(19) United States
(12) Patent Application Publication
(10) Pub. No.: US 2014/0143733 A1
(43) Pub. Date: May 22, 2014

(54) IMAGE DISPLAY APPARATUS AND METHOD FOR OPERATING THE SAME

(71) Applicant: LG Electronics INC., Seoul (KR)

(72) Inventors: Youngkyung JUNG, Seoul (KR); Jayoen KIM, Seoul (KR); Kyoungha LEE, Seoul (KR)

(73) Assignee: LG ELECTRONICS INC., Seoul (KR)

(21) Appl. No.: 14/038,231

(22) Filed: Sep. 26, 2013

(30) Foreign Application Priority Data
Nov. 16, 2012 (KR) 10-2012-0130447

(51) Int. Cl. G06F 3/0481

(52) U.S. Cl. CPC G06F 3/04815
USPC 715/848

(57) ABSTRACT

An image display apparatus and a method for operating the same are disclosed. The method for operating the image display apparatus includes displaying a two-dimensional (2D) content screen, converting 2D content into three-dimensional (3D) content when a first hand gesture is input and displaying the converted 3D content. Therefore, it is possible to increase user convenience.

### CROSS-REFERENCE TO RELATED APPLICATION

This application claims the priority benefit of Korean Patent Application No. 10-2012-0130447, filed on Nov. 16, 2012, in the Korean Intellectual Property Office, the disclosure of which is incorporated herein by reference.

### BACKGROUND OF THE INVENTION

1. Field of the Invention

The present invention relates to an image display apparatus and a method for operating the same, and more particularly, to an image display apparatus and a method for operating the same, which are capable of increasing user convenience.

2. Description of the Related Art

An image display apparatus functions to display images to a user. A user can view a broadcast program using an image display apparatus. The image display apparatus can display a broadcast program selected by the user on a display from among broadcast programs transmitted from broadcast stations. The recent trend in broadcasting is a worldwide transition from analog broadcasting to digital broadcasting.

Digital broadcasting transmits digital audio and video signals. Digital broadcasting offers many advantages over analog broadcasting, such as robustness against noise, less data loss, ease of error correction, and the ability to provide clear, high-definition images. Digital broadcasting also allows interactive viewer services, compared to analog broadcasting.

### SUMMARY OF THE INVENTION

Therefore, the present invention has been made in view of the above problems, and it is an object of the present invention to provide an image display apparatus and a method for operating the same, which are capable of increasing user convenience.

Another object of the present invention is to provide an image display apparatus and a method for operating the same that are capable of easily converting two-dimensional (2D) content into three-dimensional (3D) content.

In accordance with an aspect of the present invention, the above and other objects can be accomplished by the provision of a method for operating an image display apparatus, including displaying a two-dimensional (2D) content screen, converting 2D content into three-dimensional (3D) content when a first hand gesture is input and displaying the converted 3D content.

In accordance with another aspect of the present invention, there is provided a method for operating an image display apparatus including displaying a two-dimensional (2D) content screen, displaying an object indicating that the displayed content is 2D content, when a gesture of requesting conversion of 2D content into three-dimensional (3D) content is input, converting 2D content into 3D content based on the gesture, displaying an object indicating that the 2D content is being converted into 3D content, during content conversion, and displaying the converted 3D content after content conversion.

In accordance with another aspect of the present invention, there is provided an image display apparatus including a camera configured to acquire a captured image, a display configured to display a two-dimensional (2D) content screen, and a controller configured to recognize input of a first hand gesture based on the captured image, to convert 2D content into three-dimensional (3D) content based on the input first hand gesture, and to control display of the converted 3D content.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram showing the appearance of an image display apparatus according to an embodiment of the present invention;

FIG. 2 is a view showing a lens unit and a display of the image display apparatus of FIG. 1;

FIG. 3 is a block diagram showing the internal configuration of an image display apparatus according to an embodiment of the present invention;

FIG. 4 is a block diagram showing the internal configuration of a controller of FIG. 3;

FIG. 5 is a diagram showing a method of controlling a remote controller of FIG. 3;

FIG. 6 is a block diagram showing the internal configuration of the remote controller of FIG. 3;

FIG. 7 is a diagram illustrating images formed by a left-eye image and a right-eye image;

FIG. 8 is a diagram illustrating the depth of a 3D image according to a disparity between a left-eye image and a right-eye image;

FIG. 9 is a view referred to for describing the principle of a glassless stereoscopic image display apparatus;

FIGS. 10 to 14 are views referred to for describing the principle of an image display apparatus including multi-view images;

FIGS. 15a to 15b are views referred to for describing a user gesture recognition principle;

FIG. 16 is a view referred to for describing operation corresponding to a user gesture;

FIG. 17 is a flowchart illustrating a method for operating an image display apparatus according to an embodiment of the present invention; and

FIGS. 18a to 26 are views referred to for describing various examples of the method for operating the image display apparatus of FIG. 17.

### DETAILED DESCRIPTION OF THE PREFERRED EMBODIMENTS

Exemplary embodiments of the present invention will be described with reference to the attached drawings.

The terms “module” and “unit” used in description of components are used herein to help the understanding of the components and thus should not be misconstrued as having specific meanings or roles. Accordingly, the terms “module” and “unit” may be used interchangeably.

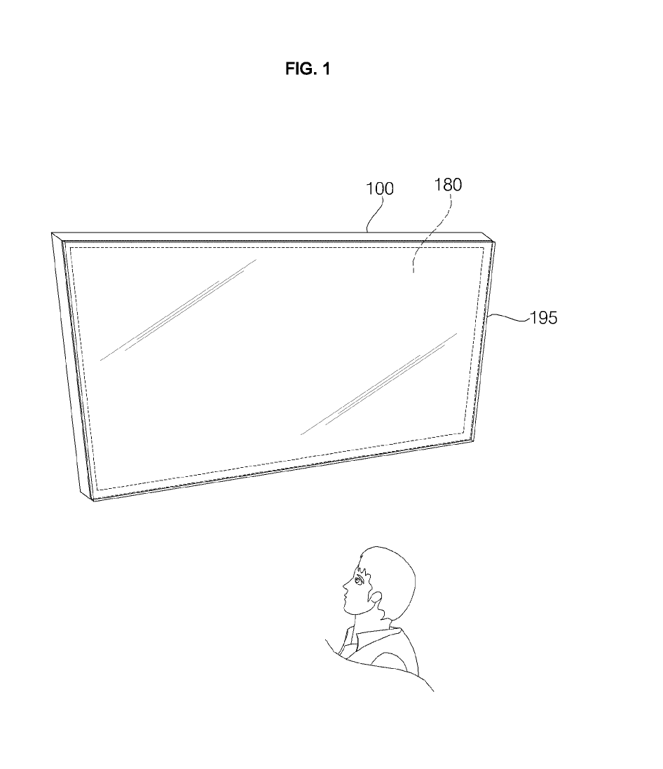

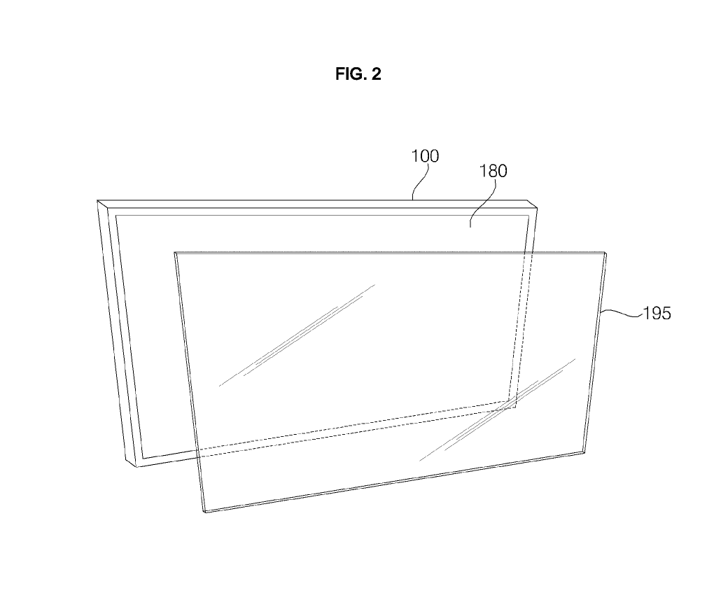

FIG. 1 is a diagram showing the appearance of an image display apparatus according to an embodiment of the present invention, and FIG. 2 is a view showing a lens unit and a display of the image display apparatus of FIG. 1.

Referring to the figures, the image display apparatus according to the embodiment of the present invention is able to display a stereoscopic image, that is, a three-dimensional (3D) image. In the embodiment of the present invention, a glassless 3D image display apparatus is used.

The image display apparatus 100 includes a display 180 and a lens unit 195.

The display 180 may display an input image and, more particularly, may display multi-view images according to the embodiment of the present invention. More specifically, subpixels configuring the multi-view images are arranged in a predetermined pattern.

The lens unit 195 may be spaced apart from the display 180 at a side close to a user. In FIG. 2, the display 180 and the lens unit 195 are separated.

The lens unit 195 may be configured to change a travel direction of light according to supplied power. For example, if a plurality of viewers views a 2D image, first power may be supplied to the lens unit 195 to emit light in the same direction as light emitted from the display 180. Thus, the image display apparatus 100 may provide a 2D image to the plurality of viewers.

In contrast, if the plurality of viewers views a 3D image, second power may be supplied to the lens unit 195 such that light emitted from the display 180 is scattered. Thus, the image display apparatus 100 may provide a 3D image to the plurality of viewers.

The lens unit 195 may use a lenticular method using a lenticular lens, a parallax method using a slit array, a method of using a micro lens array, etc. In the embodiment of the present invention, the lenticular method will be focused upon.

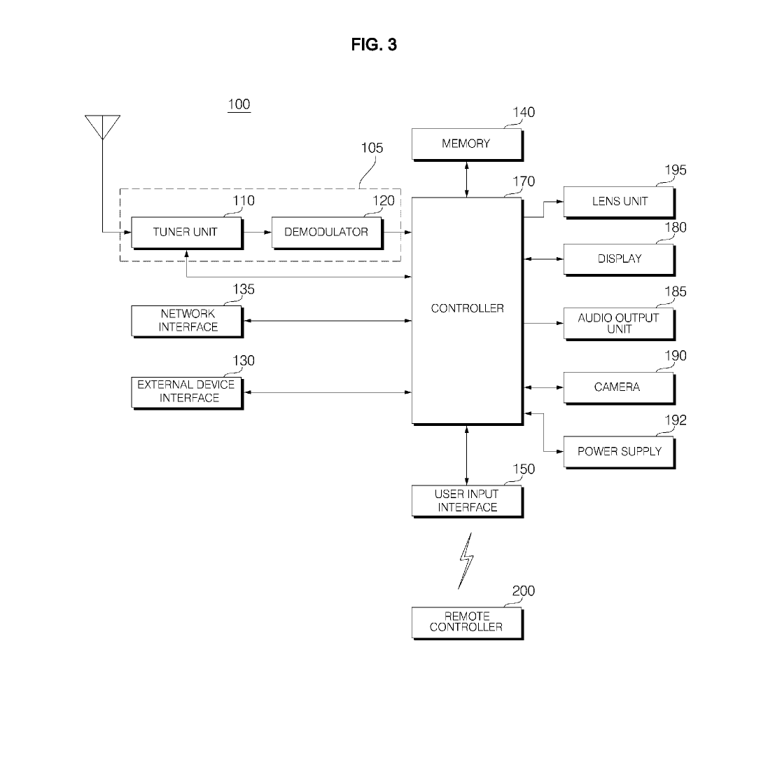

FIG. 3 is a block diagram showing the internal configuration of an image display apparatus according to an embodiment of the present invention.

Referring to FIG. 3, the image display apparatus 100 according to the embodiment of the present invention includes a broadcast reception unit 105, an external device interface 130, a memory 140, a user input interface 150, a camera unit 190, a sensor unit (not shown), a controller 170, a display 180, an audio output unit 185, a power supply 192 and a lens unit 195.

The broadcast reception unit 105 may include a tuner unit 110, a demodulator 120 and a network interface 130. As needed, the broadcasting reception unit 105 may be configured so as to include only the tuner unit 110 and the demodulator 120 or only the network interface 130.

The tuner unit 110 tunes to a Radio Frequency (RF) broadcast signal corresponding to a channel selected by a user from among RF broadcast signals received through an antenna or RF broadcast signals corresponding to all channels previously stored in the image display apparatus. The tuned RF broadcast is converted into an Intermediate Frequency (IF) signal or a baseband Audio/Video (AV) signal.

For example, the tuned RF broadcast signal is converted into a digital IF signal DIF if it is a digital broadcast signal and is converted into an analog baseband AV signal (Composite Video Banking Sync/Sound Intermediate Frequency (CVBS/SIF)) if it is an analog broadcast signal. That is, the tuner unit 110 may be capable of processing not only digital broadcast signals but also analog broadcast signals. The analog baseband A/V signal CVBS/SIF may be directly input to the controller 170.

The tuner unit 110 may be capable of receiving RF broadcast signals from an Advanced Television Systems Committee (ATSC) single-carrier system or from a Digital Video Broadcasting (DVB) multi-carrier system.

The tuner unit 110 may sequentially select a number of RF broadcast signals corresponding to all broadcast channels previously stored in the image display apparatus by a channel storage function from among a plurality of RF signals received through the antenna and may convert the selected RF broadcast signals into IF signals or baseband A/V signals.

The tuner unit 110 may include a plurality of tuners for receiving broadcast signals corresponding to a plurality of channels or include a single tuner for simultaneously receiving broadcast signals corresponding to the plurality of channels.

The demodulator 120 receives the digital IF signal DIF from the tuner unit 110 and demodulates the digital IF signal DIF.

The demodulator 120 may perform demodulation and channel decoding, thereby obtaining a stream signal TS. The stream signal may be a signal in which a video signal, an audio signal and a data signal are multiplexed.

The stream signal output from the demodulator 120 may be input to the controller 170 and thus subjected to demultiplexing and A/V signal processing. The processed video and audio signals are output to the display 180 and the audio output unit 185, respectively.

The external device interface 130 may transmit or receive data to or from a connected external device (not shown). The external device interface 130 may include an A/V Input/Output (I/O) unit (not shown) or a radio transceiver (not shown).

The external device interface 130 may be connected to an external device such as a Digital Versatile Disc (DVD) player, a Blu-ray player, a game console, a camera, a camcorder, or a computer (e.g., a laptop computer), wirelessly or by wire so as to perform an input/output operation with respect to the external device.

The A/V I/O unit may receive video and audio signals from an external device. The radio transceiver may perform short-range wireless communication with another electronic apparatus.

The network interface 135 serves as an interface between the image display apparatus 100 and a wired/wireless network such as the Internet. For example, the network interface 135 may receive content or data provided by an Internet or content provider or a network operator over a network.

The memory 140 may store various programs necessary for the controller 170 to process and control signals, and may also store processed video, audio and data signals.

In addition, the memory 140 may temporarily store a video, audio and/or data signal received from the external device interface 130. The memory 140 may store information about a predetermined broadcast channel by the channel storage function of a channel map.

While the memory 140 is shown in FIG. 3 as being configured separately from the controller 170, to which the present invention is not limited, the memory 140 may be incorporated into the controller 170.

The user input interface 150 transmits a signal input by the user to the controller 170 or transmits a signal received from the controller 170 to the user.

For example, the user input interface 150 may transmit/receive various user input signals such as a power-on/off signal, a channel selection signal, and a screen setting signal from a remote controller 200, may provide the controller 170 with user input signals received from local keys (not shown), such as inputs of a power key, a channel key, and a volume key, and setting values, provide the controller 170 with a user input signal received from a sensor unit (not shown) for sensing a user gesture, or transmit a signal received from the controller 170 to a sensor unit (not shown).

The controller 170 may demultiplex the stream signal received from the tuner unit 110, the demodulator 120, or the external device interface 130 into a number of signals, process the demultiplexed signals into audio and video data, and output the audio and video data.

The video signal processed by the controller 170 may be displayed as an image on the display 180. The video signal processed by the controller 170 may also be transmitted to an external output device through the external device interface 130.

The audio signal processed by the controller 170 may be output to the audio output unit 185. In addition, the audio signal processed by the controller 170 may be transmitted to the external output device through the external device interface 130.

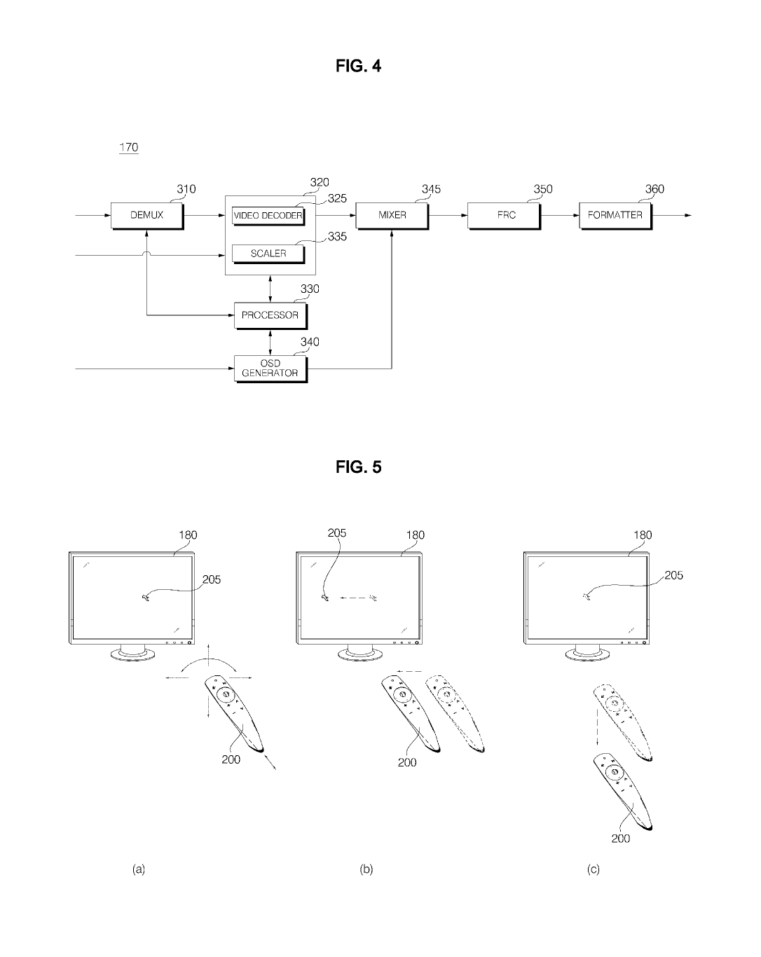

While not shown in FIG. 3, the controller 170 may include a DEMUX, a video processor, etc., which will be described in detail later with reference to FIG. 4.

The controller 170 may control the overall operation of the image display apparatus 100. For example, the controller 170 controls the tuner unit 110 to tune to an RF signal corresponding to a channel selected by the user or a previously stored channel.

The controller 170 may control the image display apparatus 100 according to a user command input through the user input interface 150 or an internal program.

The controller 170 may control the display 180 to display images. The image displayed on the display 180 may be a Two-Dimensional (2D) or Three-Dimensional (3D) still or moving image.

The controller 170 may generate and display a predetermined object of an image displayed on the display 180 as a 3D object. For example, the object may be at least one of a screen of an accessed web site (newspaper, magazine, etc.), an electronic program guide (EPG), various menus, a widget, an icon, a still image, a moving image, text, etc.

Such a 3D object may be processed to have a depth different from that of an image displayed on the display 180. Preferably, the 3D object may be processed so as to appear to protrude from the image displayed on the display 180.

The controller 170 may recognize the position of the user based on an image captured by the camera unit 190. For example, a distance (z-axis coordinate) between the user and the image display apparatus 100 may be detected. An x-axis coordinate and a y-axis coordinate in the display 180 corresponding to the position of the user may be detected.

The controller 170 may recognize a user gesture based on the user image captured by the camera unit 190 and, more particularly, determine whether a gesture is activated using a distance between a hand and eyes of the user. Alternatively, the controller 170 may recognize other gestures according to various hand motions and arm motions.

The controller 170 may control operation of the lens unit 195. For example, the controller 170 may control first power to be supplied to the lens unit 195 upon 2D image display and second power to be supplied to the lens unit 195 upon 3D image display. Thus, light may be emitted in the same direction as light emitted from the display 180 through the lens unit 195 upon 2D image display and light emitted from the display 180 may be scattered via the lens unit 195 upon 3D image display.

Although not shown, the image display apparatus may further include a channel browsing processor (not shown) for generating thumbnail images corresponding to channel signals or external input signals. The channel browsing processor may receive stream signals TS received from the demodulator 120 or stream signals received from the external device interface 130, extract images from the received stream signal, and generate thumbnail images. The thumbnail images may be decoded and output to the controller 170, along with the decoded images. The controller 170 may display thumbnail list including a plurality of received thumbnail images on the display 180 using the received thumbnail images.

The thumbnail list may be displayed using a simple viewing method of displaying the thumbnail list in a part of an area in a state of displaying a predetermined image or may be displayed in a full viewing method of displaying the thumbnail list in a full area. The thumbnail images in the thumbnail list may be sequentially updated.

The display 180 converts the video signal, the data signal, the OSD signal and the control signal processed by the controller 170 or the video signal, the data signal and the control signal received by the external device interface 130 and generates a drive signal.

The display 180 may be a Plasma Display Panel (PDP), a Liquid Crystal Display (LCD), an Organic Light-Emitting Diode (OLED) display or a flexible display. In particular, the display 180 may be a 3D display.

As described above, the display 180 according to the embodiment of the present invention is a glassless 3D image display that does not require glasses. The display 180 includes the lenticular lens unit 195.

The power supply 192 supplies power to the image display apparatus 100. Thus, the modules or units of the image display apparatus 100 may operate.

The display 180 may be configured to include a 2D image region and a 3D image region. In this case, the power supply 192 may supply different first power and second power to the lens unit 195. First power and second power may be supplied under control of the controller 170.

The lens unit 195 changes a travel direction of light according to supplied power.

First power may be supplied to a first region of the lens unit corresponding to a 2D image region of the display 180 such that light may be emitted in the same direction as light emitted from the 2D image region of the display 180. Thus, the user may perceive the displayed image as a 2D image.

As another example, second power may be supplied to a second region of the lens unit corresponding to a 3D image region of the display 180 such that light emitted from the 3D image region of the display 180 is scattered. Thus, the user may perceive the displayed image as a 3D image without wearing glasses.

The lens unit 195 may be spaced from the display 180 at a user side. In particular, the lens unit 195 may be provided in parallel to the display 180, may be provided to be inclined with respect to the display 180 at a predetermined angle or may be concave or convex with respect to the display 180. The lens unit 195 may be provided in the form of a sheet. The lens unit 195 according to the embodiment of the present invention may be referred to as a lens sheet.

If the display 180 is a touchscreen, the display 180 may function as not only an output device but also as an input device.

The audio output unit 185 receives the audio signal processed by the controller 170 and outputs the received audio signal as sound.

The camera unit 190 captures images of a user. The camera unit (not shown) may be implemented by one camera, but the present invention is not limited thereto. That is, the camera unit may be implemented by a plurality of cameras. The camera unit 190 may be embedded in the image display apparatus 100 at the upper side of the display 180 or may be separately provided. Image information captured by the camera unit 190 may be input to the controller 170.

The controller 170 may sense a user gesture from an image captured by the camera unit 190, a signal sensed by the sensor unit (not shown), or a combination of the captured image and the sensed signal.

The remote controller 200 transmits user input to the user input interface 150. For transmission of user input, the remote controller 200 may use various communication techniques such as Bluetooth, RF communication, IR communication, Ultra Wideband (UWB), and ZigBee. In addition, the remote controller 200 may receive a video signal, an audio signal or a data signal from the user input interface 150 and output the received signals visually or audibly based on the received video, audio or data signal.

The image display apparatus 100 may be a fixed or mobile digital broadcast receiver.

The image display apparatus described in the present specification may include a TV receiver, a monitor, a mobile phone, a smart phone, a notebook computer, a digital broadcast terminal, a Personal Digital Assistant (PDA), a Portable Multimedia Player (PMP), etc.

The block diagram of the image display apparatus 100 illustrated in FIG. 3 is only exemplary. Depending upon the specifications of the image display apparatus 100, the components of the image display apparatus 100 may be combined or omitted or new components may be added. That is, two or more components are incorporated into one component or one component may be configured as separate components, as needed. In addition, the function of each block is described for the purpose of describing the embodiment of the present invention and thus specific operations or devices should not be construed as limiting the scope and spirit of the present invention.

Unlike FIG. 3, the image display apparatus 100 may not include the tuner unit 110 and the demodulator 120 shown in FIG. 3 and may receive image content through the network interface 135 or the external device interface 130 and reproduce the image content.

The image display apparatus 100 is an example of an image signal processing apparatus that processes an image stored in the apparatus or an input image. Other examples of the image signal processing apparatus include a set-top box without the display 180 and the audio output unit 185, a DVD player, a Blu-ray player, a game console, and a computer.

FIG. 4 is a block diagram showing the internal configuration of the controller of FIG. 3.

Referring to FIG. 4, the controller 170 according to the embodiment of the present invention may include a DEMUX 310, a video processor 320, a processor 330, an OSD generator 340, a mixer 345, a Frame Rate Converter (FRC) 350, and a formatter 360. The controller 170 may further include an audio processor (not shown) and a data processor (not shown).

The DEMUX 310 demultiplexes an input stream. For example, the DEMUX 310 may demultiplex an MPEG-2 TS into a video signal, an audio signal, and a data signal. The stream signal input to the DEMUX 310 may be received from the tuner unit 110, the demodulator 120 or the external device interface 130.

The video processor 320 may process the demultiplexed video signal. For video signal processing, the video processor 320 may include a video decoder 325 and a scaler 335.

The video decoder 325 decodes the demultiplexed video signal and the scaler 335 scales the resolution of the decoded video signal so that the video signal can be displayed on the display 180.

The video decoder 325 may be provided with decoders that operate based on various standards.

The video signal decoded by the video processor 320 may include a 2D video signal, a mixture of a 2D video signal and a 3D video signal, or a 3D video signal.

For example, if an external video signal received from the external device (not shown) or a broadcast video signal received from the tuner unit 110 includes a 2D video signal, a mixture of a 2D video signal and a 3D video signal, or a 3D video signal. Thus, the controller 170 and, more particularly, the video processor 320 may perform signal processing and output a 2D video signal, a mixture of a 2D video signal and a 3D video signal, or a 3D video signal.

The decoded video signal from the video processor 320 may have any of various available formats. For example, the decoded video signal may be a 3D video signal composed of a color image and a depth image or a 3D video signal composed of multi-view image signals. The multi-view image signals may include, for example, a left-eye image signal and a right-eye image signal.

Formats of the 3D video signal may include a side-by-side format in which the left-eye image signal L and the right-eye image signal R are arranged in a horizontal direction, a top/down format in which the left-eye image signal and the right-eye image signal are arranged in a vertical direction, a frame sequential format in which the left-eye image signal and the right-eye image signal are time-divisionally arranged, an interlaced format in which the left-eye image signal and the right-eye image signal are mixed in line units, and a checker box format in which the left-eye image signal and the right-eye image signal are mixed in box units.

The processor 330 may control overall operation of the image display apparatus 100 or the controller 170. For example, the processor 330 may control the tuner unit 110 to tune to an RF broadcast corresponding to an RF signal corresponding to a channel selected by the user or a previously stored channel.

The processor 330 may control the image display apparatus 100 by a user command input through the user input interface 150 or an internal program.

The processor 330 may control data transmission of the network interface 135 or the external device interface 130.

The processor 330 may control the operation of the DEMUX 310, the video processor 320 and the OSD generator 340 of the controller 170.

The OSD generator 340 generates an OSD signal autonomously or according to user input. For example, the OSD generator 340 may generate signals by which a variety of information is displayed as graphics or text on the display 180, according to user input signals. The OSD signal may include a variety of data such as a User Interface (UI), a variety of menus, widgets, icons, etc. In addition, the OSD signal may include a 2D object and/or a 3D object.

The OSD generator 340 may generate a pointer which can be displayed on the display according to a pointing signal received from the remote controller 200. In particular, such a pointer may be generated by a pointing signal processor and the OSD generator 340 may include such a pointing signal processor (not shown). Alternatively, the pointing signal processor (not shown) may be provided separately from the OSD generator 340.

The mixer 345 may mix the decoded video signal processed by the video processor 320 with the OSD signal generated by the OSD generator 340. Each of the OSD signal and the decoded video signal may include at least one of a 2D signal and a 3D signal. The mixed video signal is provided to the FRC 350.

The FRC 350 may change the frame rate of an input image. The FRC 350 may maintain the frame rate of the input image without frame rate conversion.

The formatter 360 may arrange 3D images subjected to frame rate conversion.

The formatter 360 may receive the signal mixed by the mixer 345, that is, the OSD signal and the decoded video signal, and separate a 2D video signal and a 3D video signal.

In the present specification, a 3D video signal refers to a signal including a 3D object such as a Picture-In-Picture (PIP) image (still or moving), an EPG that describes broadcast programs, a menu, a widget, an icon, text, an object within an image, a person, a background, or a web page (e.g. from a newspaper, a magazine, etc.).

The formatter 360 may change the format of the 3D video signal. For example, if 3D video is received in the various formats described above, video may be changed to a multi-view image. In particular, the multi-view image may be repeated. Thus, it is possible to display glassless 3D video.

Meanwhile, the formatter 360 may convert a 2D video signal into a 3D video signal. For example, the formatter 360 may detect edges or a selectable object from the 2D video signal and generate an object according to the detected edges or the selectable object as a 3D video signal. As described above, the 3D video signal may be a multi-view image signal.

Although not shown, a 3D processor (not shown) for 3D effect signal processing may be further provided next to the formatter 360. The 3D processor (not shown) may control brightness, tint, and color of the video signal, to enhance the 3D effect.

The audio processor (not shown) of the controller 170 may process the demultiplexed audio signal. For audio processing, the audio processor (not shown) may include various decoders.

The audio processor (not shown) of the controller 170 may also adjust the bass, treble or volume of the audio signal.

The data processor (not shown) of the controller 170 may process the demultiplexed data signal. For example, if the demultiplexed data signal was encoded, the data processor may decode the data signal. The encoded data signal may be Electronic Program Guide (EPG) information including broadcasting information such as the start time and end time of broadcast programs of each channel.

Although the formatter 360 performs 3D processing after the signals from the OSD generator 340 and the video processor 320 are mixed by the mixer 345 in FIG. 4, the present invention is not limited thereto and the mixer may be located at a next stage of the formatter. That is, the formatter 360 may perform 3D processing with respect to the output of the video processor 320, the OSD generator 340 may generate the OSD signal and perform 3D processing with respect to the OSD signal, and then the mixer 345 may mix the respective 3D signals.

The block diagram of the controller 170 shown in FIG. 4 is exemplary. The components of the block diagrams may be integrated or omitted, or a new component may be added according to the specifications of the controller 170.

In particular, the FRC 350 and the formatter 360 may be included separately from the controller 170.

FIG. 5 is a diagram showing a method of controlling a remote controller of FIG. 3.

As shown in FIG. 5(a), a pointer 205 representing movement of the remote controller 200 is displayed on the display 180.

The user may move or rotate the remote controller 200 up and down, side to side (FIG. 5(b)), and back and forth (FIG. 5(c)). The pointer 205 displayed on the display 180 of the image display apparatus corresponds to the movement of the remote controller 200. Since the pointer 205 moves according to movement of the remote controller 200 in a 3D space as shown in the figure, the remote controller 200 may be referred to as a pointing device.

Referring to FIG. 5(b), if the user moves the remote controller 200 to the left, the pointer 205 displayed on the display 180 of the image display apparatus 200 moves to the left.

A sensor of the remote controller 200 detects movement of the remote controller 200 and transmits motion information corresponding to the result of detection to the image display apparatus. Then, the image display apparatus may calculate the coordinates of the pointer 205 from the motion information of the remote controller 200. The image display apparatus then displays the pointer 205 at the calculated coordinates.

Referring to FIG. 5(c), while pressing a predetermined button of the remote controller 200, the user moves the remote controller 200 away from the display 180. Then, a selected area corresponding to the pointer 205 may be zoomed in on and enlarged on the display 180. On the contrary, if the user moves the remote controller 200 toward the display 180, the selection area corresponding to the pointer 205 is zoomed out and thus contracted on the display 180. Alternatively, when the remote controller 200 moves away from the display 180, the selection area may be zoomed out on and when the remote controller 200 approaches the display 180, the selection area may be zoomed in on.

With the predetermined button pressed in the remote controller 200, the up, down, left and right movement of the remote controller 200 may be ignored. That is, when the remote controller 200 moves away from or approaches the display 180, only the back and forth movements of the remote controller 200 are sensed, while the up, down, left and right movements of the remote controller 200 are ignored. If the predetermined button of the remote controller 200 is not pressed, only the pointer 205 moves in accordance with the up, down, left or right movement of the remote controller 200.

The speed and direction of the pointer 205 may correspond to the speed and direction of the remote controller 200.

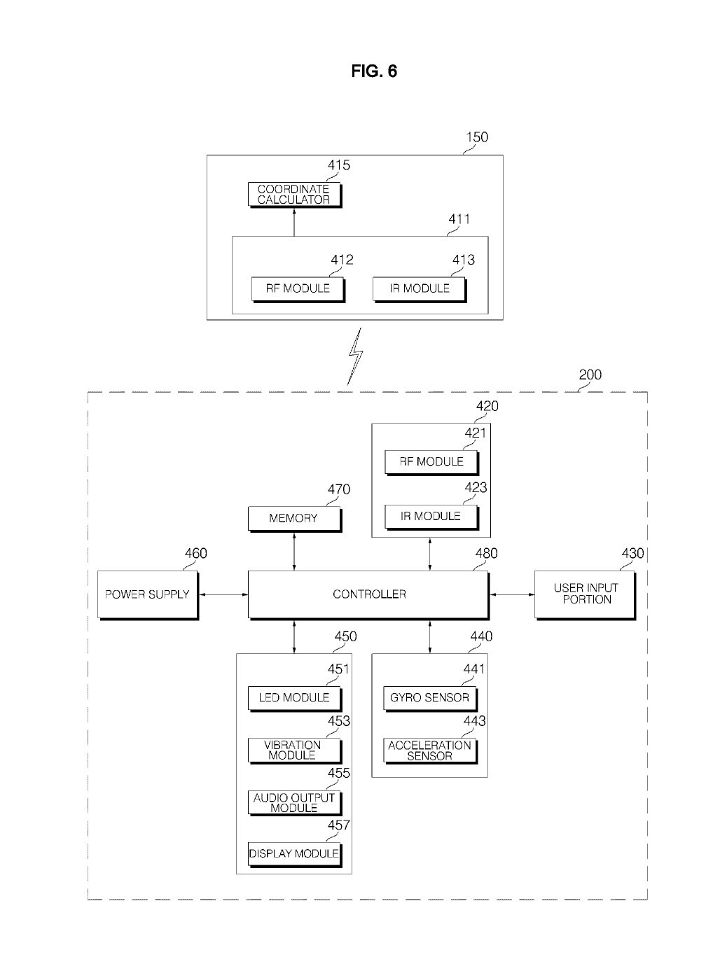

FIG. 6 is a block diagram showing the internal configuration of the remote controller of FIG. 3.

Referring to FIG. 6, the remote controller 200 may include a radio transceiver 420, a user input portion 430, a sensor portion 440, an output portion 450, a power supply 460, a memory 460, and a controller 480.

The radio transceiver 420 transmits and receives signals to and from any one of the image display apparatuses according to the embodiments of the present invention. Among the image display apparatuses according to the embodiments of the present invention, for example, one image display apparatus 100 will be described.

In accordance with the exemplary embodiment of the present invention, the remote controller 200 may include an RF module 421 for transmitting and receiving signals to and from the image display apparatus 100 according to an RF communication standard. Additionally, the remote controller 200 may include an IR module 423 for transmitting and receiving signals to and from the image display apparatus 100 according to an IR communication standard.

In the present embodiment, the remote controller 200 may transmit information about movement of the remote controller 200 to the image display apparatus 100 via the RF module 421.

The remote controller 200 may receive the signal from the image display apparatus 100 via the RF module 421. The remote controller 200 may transmit commands associated with power on/off, channel change, volume change, etc. to the image display apparatus 100 through the IR module 423.

The user input portion 430 may include a keypad, a key (button), a touch pad or a touchscreen. The user may enter a command related to the image display apparatus 100 to the remote controller 200 by manipulating the user input portion 430. If the user input portion 430 includes hard keys, the user may enter commands related to the image display apparatus 100 to the remote controller 200 by pushing the hard keys. If the user input portion 430 is provided with a touchscreen, the user may enter commands related to the image display apparatus 100 through the remote controller 200 by touching soft keys on the touchscreen. Additionally, the user input portion 430 may have a variety of input means that can be manipulated by the user, such as a scroll key, a jog key, etc., to which the present invention is not limited thereto.

The sensor portion 440 may include a gyro sensor 441 or an acceleration sensor 443. The gyro sensor 441 may sense information about movement of the remote controller 200.

For example, the gyro sensor 441 may sense information about movement of the remote controller 200 along x, y and z axes. The acceleration sensor 443 may sense information about the speed of the remote controller 200. The sensor portion 440 may further include a distance measurement sensor for sensing a distance from the display 180.

The output portion 450 may output a video or audio signal corresponding to manipulation of the user input portion 430 or a signal transmitted by the image display apparatus 100. The output portion 450 lets the user know whether the user input portion 430 has been manipulated or the image display apparatus 100 has been controlled.

For example, the output portion 450 may include a Light Emitting Diode (LED) module 451 for illuminating when the user input portion 430 has been manipulated or a signal is transmitted to or received from the image display apparatus 100 through the radio transceiver 420, a vibration module 453 for generating vibrations, an audio output module 455 for outputting audio, or a display module 457 for outputting video.

The power supply 460 supplies power to the remote controller 200. When the remote controller 200 remains stationary for a predetermined time, the power supply 460 blocks power from the remote controller 200, thereby preventing unnecessary power consumption. When a predetermined key of the remote controller 200 is manipulated, the power supply 460 may resume power supply.

The memory 470 may store a plurality of types of programs required for control or operation of the remote controller 200, or application data. When the remote controller 200 transmits and receives signals to and from the image display apparatus 100 wirelessly through the RF module 421, the remote controller 200 and the image display apparatus 100 perform signal transmission and reception in a predetermined frequency band. The controller 480 of the remote controller 200 may store information about the frequency band in which signals are wirelessly transmitted received to and from the image display apparatus 100 paired with the remote controller 200 in the memory 470 and refer to the information.

The controller 480 provides overall control to the remote controller 200. The controller 480 may transmit a signal corresponding to predetermined key manipulation of the user input portion 430 or a signal corresponding to movement of the remote controller 200 sensed by the sensor portion 440 to the image display apparatus 100 through the radio transceiver 420.

The user input interface 150 of the image display apparatus 100 may have a radio transceiver 411 for wirelessly transmitting and receiving signals to and from the remote controller 200, and a coordinate calculator 415 for calculating the coordinates of the pointer corresponding to an operation of the remote controller 200.

The user input interface 150 may transmit and receive signals wirelessly to and from the remote controller 200 through an RF module 412. The user input interface 150 may also receive a signal from the remote controller 200 through an IR module 413 based on an IR communication standard.

The coordinate calculator 415 may calculate the coordinates (x, y) of the pointer 205 to be displayed on the display 180 by correcting hand tremor or errors from a signal corresponding to an operation of the remote controller 200 received through the radio transceiver 411.

A signal transmitted from the remote controller 200 to the image display apparatus 100 through the user input interface 150 is provided to the controller 170 of the image display apparatus 100. The controller 170 may identify information about an operation of the remote controller 200 or key manipulation of the remote controller 200 from the signal received from the remote controller 200 and control the image display apparatus 100 according to the information.

In another example, the remote controller 200 may calculate the coordinates of the pointer corresponding to the operation of the remote controller and output the coordinates to the user input interface 150 of the image display apparatus 100. The user input interface 150 of the image display apparatus 100 may then transmit information about the received coordinates of the pointer to the controller 170 without correcting hand tremor or errors.

As another example, the coordinate calculator 415 may be included in the controller 170 instead of the user input interface 150.

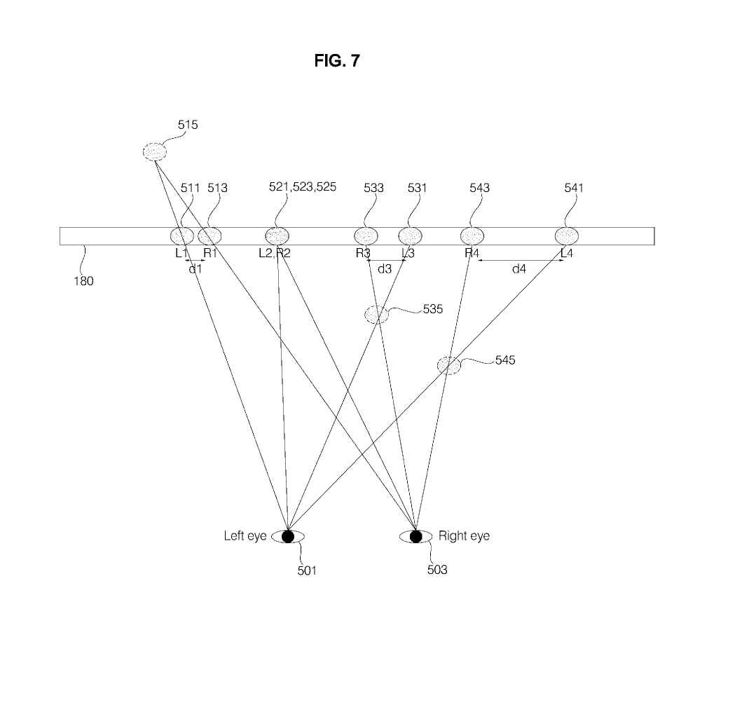

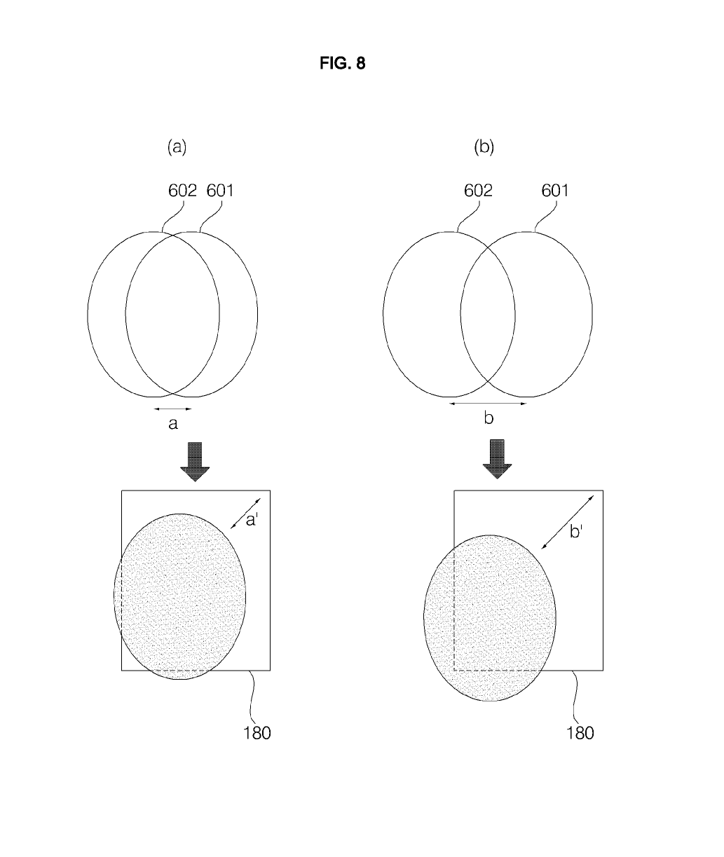

FIG. 7 is a diagram illustrating images formed by a left-eye image and a right-eye image, and FIG. 8 is a diagram illustrating the depth of a 3D image according to a disparity between a left-eye image and a right-eye image.

First, referring to FIG. 7, a plurality of images or a plurality of objects 515, 525, 535 or 545 is shown.

A first object 515 includes a first left-eye image 511 (L) based on a first left-eye image signal and a first right-eye image 513 (R) based on a first right-eye image signal, and a disparity between the first left-eye image 511 (L) and the first right-eye image 513 (R) is d1 on the display 180. The user sees an image as formed at the intersection between a line connecting a left eye 501 to the first left-eye image 511 and a line connecting a right eye 503 to the first right-eye image 513. Therefore, the user perceives the first object 515 as being located behind the display 180.

Since a second object 525 includes a second left-eye image 521 (L) and a second right-eye image 523 (R), which are displayed on the display 180 to overlap, a disparity between the second left-eye image 521 and the second right-eye image 523 is 0. Thus, the user perceives the second object 525 as being on the display 180.

A third object 535 includes a third left-eye image 531 (L) and a third right-eye image 533 (R) and a fourth object 545 includes a fourth left-eye image 541 (L) with a fourth right-eye image 543 (R). A disparity between the third left-eye image 531 and the third right-eye images 533 is d3 and a disparity between the fourth left-eye image 541 and the fourth right-eye image 543 is d4.

The user perceives the third and fourth objects 535 and 545 at image-formed positions, that is, as being positioned in front of the display 180.

Because the disparity d4 between the fourth left-eye image 541 and the fourth right-eye image 543 is greater than the disparity d3 between the third left-eye image 531 and the third right-eye image 533, the fourth object 545 appears to be positioned closer to the viewer than the third object 535.

In embodiments of the present invention, the distances between the display 180 and the objects 515, 525, 535 and 545 are represented as depths. When an object is perceived as being positioned behind the display 180, the object has a negative depth value. On the other hand, when an object is perceived as being positioned in front of the display 180, the object has a positive depth value. That is, the depth value is proportional to apparent proximity to the user.

Referring to FIG. 8, if the disparity a between a left-eye image 601 and a right-eye image 602 in FIG. 8(a) is smaller than the disparity b between the left-eye image 601 and the right-eye image 602 in FIG. 8(b), the depth a′ of a 3D object created in FIG. 8(a) is smaller than the depth b′ of a 3D object created in FIG. 8(b).

In the case where a left-eye image and a right-eye image are combined into a 3D image, the positions of the images perceived by the user are changed according to the disparity between the left-eye image and the right-eye image. This means that the depth of a 3D image or 3D object formed of a left-eye image and a right-eye image in combination may be controlled by adjusting the disparity between the left-eye and right-eye images.

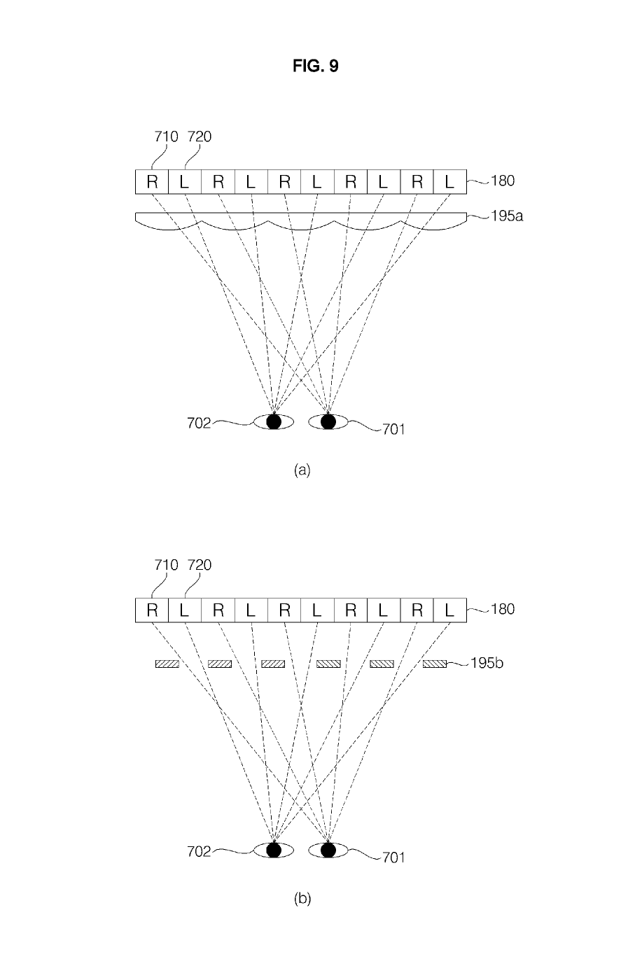

FIG. 9 is a view referred to for describing the principle of a glassless stereoscopic image display apparatus.

The glassless stereoscopic image display apparatus includes a lenticular method and a parallax method as described above and may further include a method of utilizing a microlens array. Hereinafter, the lenticular method and the parallax method will be described in detail. Although a multi-view image includes two images such as a left-eye view image and a right-eye view image in the following description, this is exemplary and the present invention is not limited thereto.

FIG. 9(a) shows a lenticular method using a lenticular lens. Referring to FIG. 9(a), a block 720 (L) configuring a left-eye view image and a block 710 (R) configuring a right-eye view image may be alternately arranged on the display 180. Each block may include a plurality of pixels or one pixel. Hereinafter, assume that each block includes one pixel.

In the lenticular method, a lenticular lens 195a is provided in a lens unit 195 and the lenticular lens 195a provided on the front surface of the display 180 may change a travel direction of light emitted from the pixels 710 and 720. For example, the travel direction of light emitted from the pixel 720 (L) configuring the left-eye view image may be changed such that the light travels toward the left eye 701 of a viewer and the travel direction of light emitted from the pixel 710 (R) configuring the right-eye view image may be changed such that the light travels toward the right eye 702 of the viewer.

Then, the light emitted from the pixel 720 (L) configuring the left-eye view image is combined such that the user views the left-eye view image via the left eye 702 and the light emitted from the pixel 710 (R) configuring the right-eye view image is combined such that the user views the right-eye view image via the right eye 701, thereby viewing a stereoscopic image without wearing glasses.

FIG. 9(b) shows a parallax method using a slit array. Referring to FIG. 9(b), similarly to FIG. 9(a), a pixel 720 (L) configuring a left-eye view image and a pixel 710 (R) configuring a right-eye view image may be alternately arranged on the display 180. In the parallax method, a slit array 195b is provided in the lens unit 195. The slit array 195b serves as a barrier which enables light emitted from the pixel to travel in a predetermined direction. Thus, similarly to the lenticular method, the user views the left-eye view image via the left eye 702 and views the right-eye view image via the right eye 701, thereby viewing a stereoscopic image without wearing glasses.

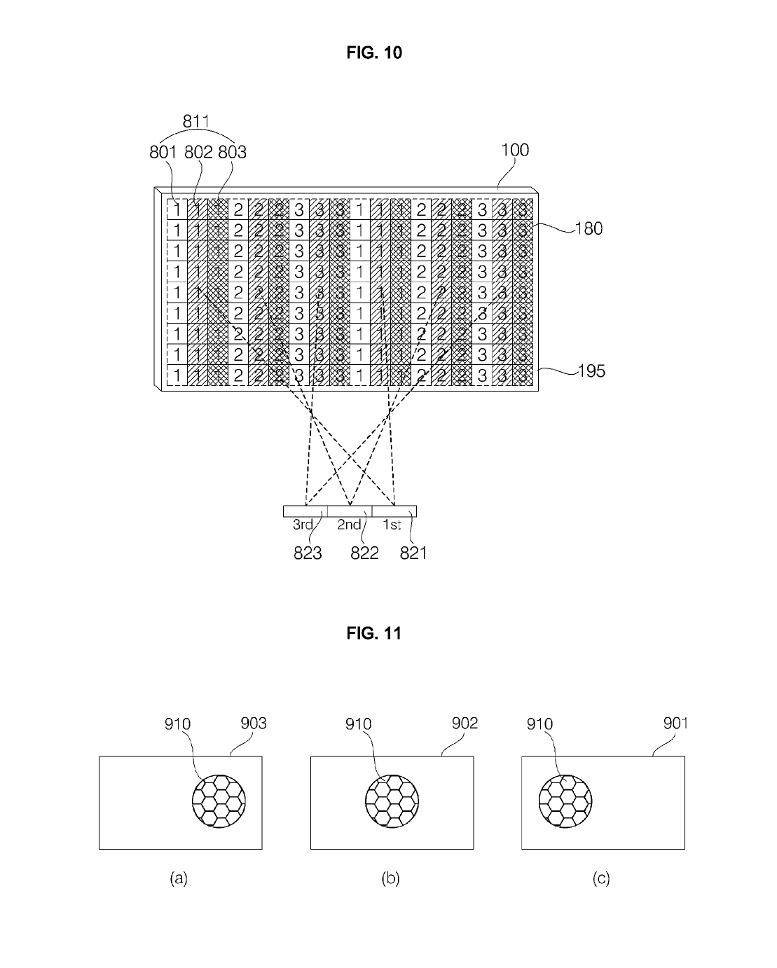

FIGS. 10 to 14 are views referred to for describing the principle of an image display apparatus including multi-view images.

FIG. 10 shows a glassless image display apparatus 100 having three view regions 821, 822 and 823 formed therein. Three view images may be recognized in the three view regions 821, 822 and 823, respectively.

Some pixels configuring the three view images may be rearranged and displayed on the display 180 as shown in FIG. 10 such that the three view images are respectively perceived in the three view regions 821, 822 and 823. At this time, rearranging the pixels does not mean that the physical positions of the pixels are changed, but means that the values of the pixels of the display 180 are changed.

The three view images may be obtained by capturing an image of an object from different directions as shown in FIG. 11. For example, FIG. 11(a) shows an image captured in a first direction, FIG. 11(b) shows an image captured in a second direction and FIG. 11(c) shows an image captured in a third direction. The first, second and third directions may be different.

In addition, FIG. 11(a) shows an image of the object 910 captured in a left direction, FIG. 11(b) shows an image of the object 910 captured in a front direction, and FIG. 11(c) shows an image of the object 910 captured in a right direction.

The first pixel 811 of the display 180 includes a first subpixel 801, a second subpixel 802 and a third subpixel 803. The first, second and third subpixels 801, 802 and 803 may be red, green and blue subpixels, respectively.

FIG. 10 shows a pattern in which the pixels configuring the three view images are rearranged, to which the present invention is not limited. The pixels may be rearranged in various patterns according to the lens unit 195.

In FIG. 10, the subpixels 801, 802 and 803 denoted by numeral 1 configure the first view image, the subpixels denoted by numeral 2 configure the second view image and, and the subpixels denoted by numeral 3 configure the third view image.

Accordingly, the subpixels denoted by numeral 1 are combined in the first view region 821 such that the first view image is perceived, the subpixels denoted by numeral 2 are combined in the second view region 822 such that the second view image is perceived, and the subpixels denoted by numeral 3 are combined in the third view region such that the third view image is perceived.

That is, the first view image 901, the second view image 902 and the third view image 903 shown in FIG. 11 are displayed according to view directions. In addition, the first view image 901 is obtained by capturing the image of the object 910 in a first view direction, the second view image 902 is obtained by capturing the image of the object 910 in a second view direction and the third view image 903 is obtained by capturing the image of the object 910 in a third view direction.

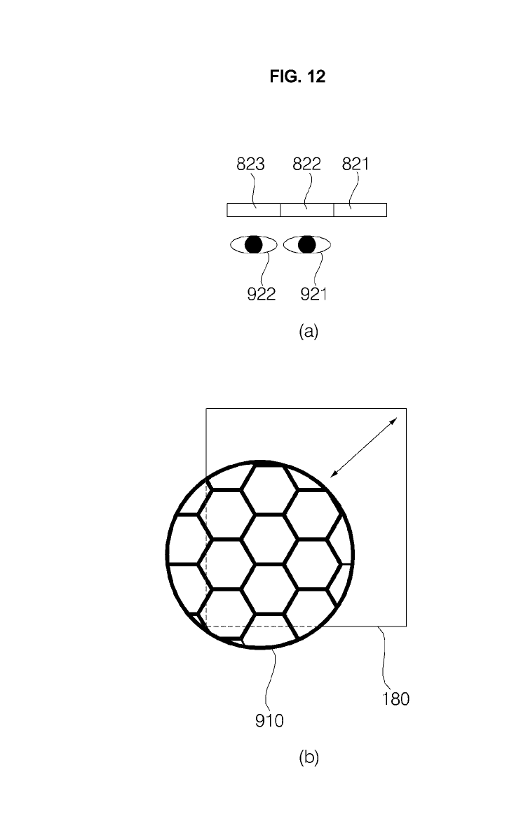

Accordingly, as shown in FIG. 12(a), if the left eye 922 of the viewer is located in the third view region 823 and the right eye 921 of the viewer thereof is located in the second view region 822, the left eye 922 views the third view image 903 and the right eye 921 views the second view image 902.

At this time, the third view image 903 is a left-eye image and the second view image 902 is a right-eye image. Then, as shown in FIG. 12(b), according to the principle described with reference to FIG. 7, the object 910 is perceived as being positioned in front of the display 180 such that the viewer perceives a stereoscopic image without wearing glasses.

In addition, even if the left eye 922 of the viewer is located in the second view region 822 and the right eye 921 thereof is located in the first view region 821, the stereoscopic image (3D image) may be perceived.

As shown in FIG. 10, if the pixels of the multi-view images are rearranged only in a horizontal direction, horizontal resolution is reduced to 1/n (n being the number of multi-view images) that of a 2D image. For example, the horizontal resolution of the stereoscopic image (3D image) of FIG. 10 is reduced to ⅓ that of a 2D image. In contrast, vertical resolution of the stereoscopic image is equal to that of the multi-view images 901, 902 and 903 before rearrangement.

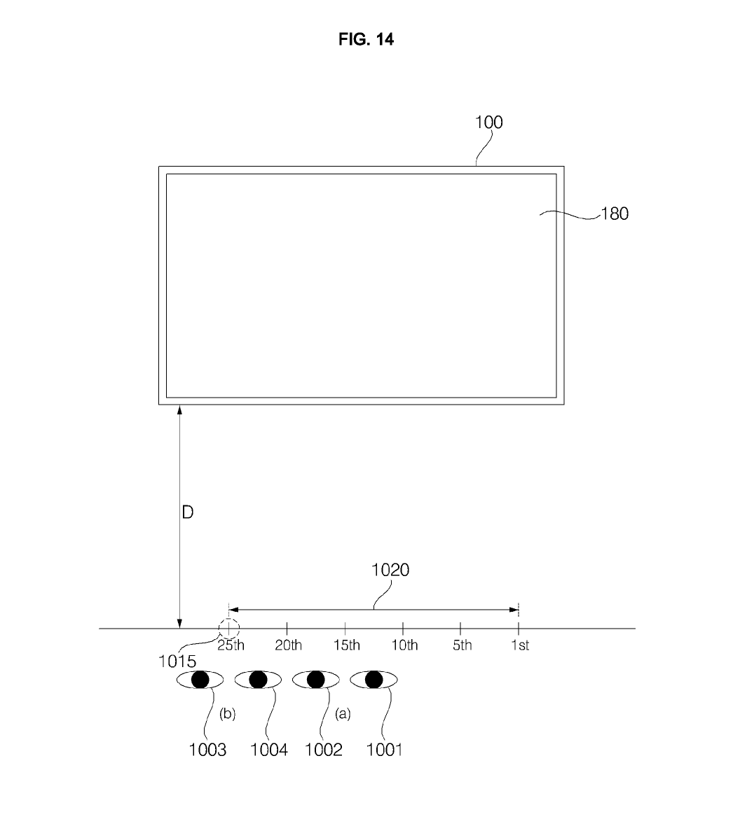

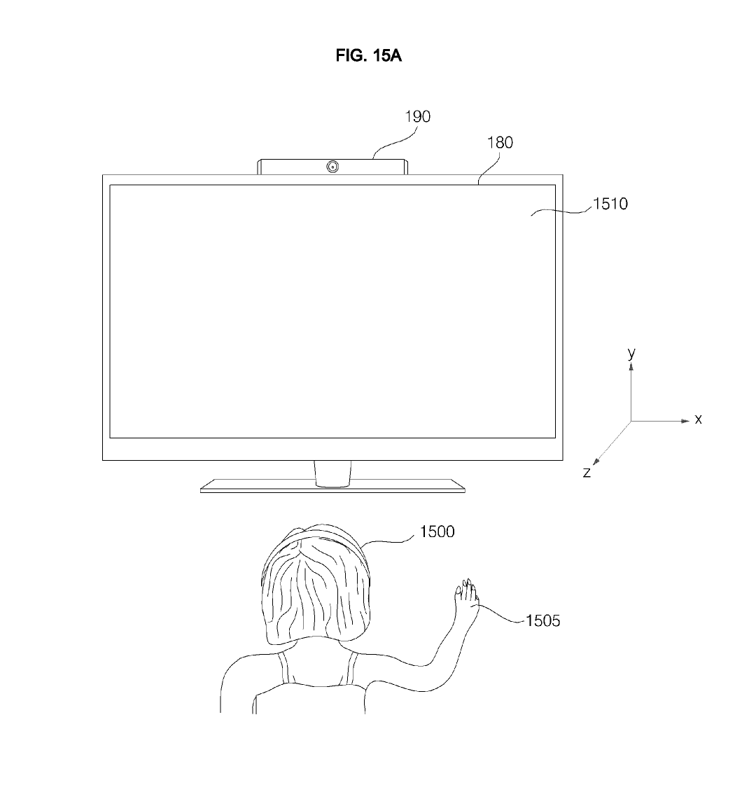

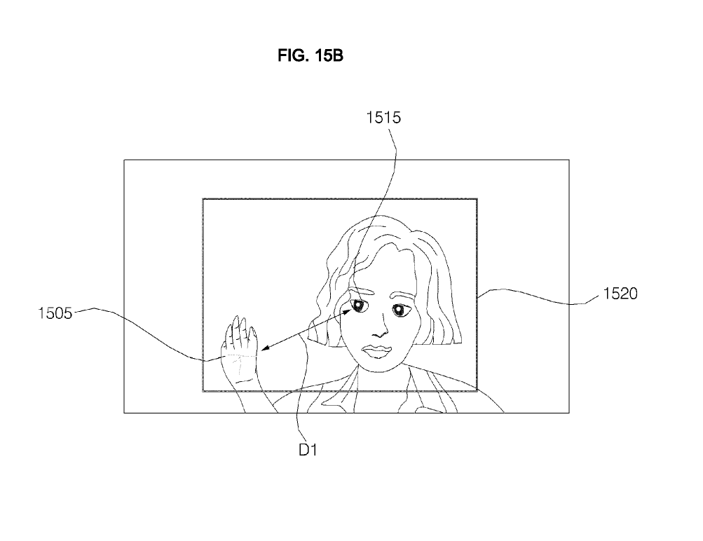

If the number of per-direction view images is large (the reason why the number of view images is increased will be described below with reference to FIG. 14), only horizontal resolution is reduced as compared to vertical resolution and resolution imbalance is severe, thereby degrading overall quality of the 3D image.

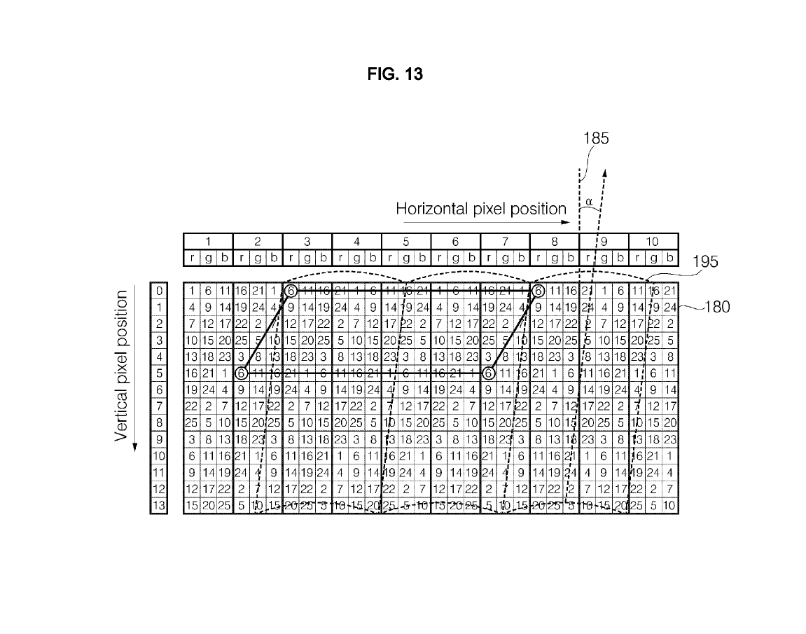

In order to solve such a problem, as shown in FIG. 13, the lens unit 195 may be placed on the front surface of the display 180 to be inclined with respect to a vertical axis 185 at a predetermined angle α and the subpixels configuring the multi-view images may be rearranged in various patterns according to the inclination angle of the lens unit 195. FIG. 13 shows an image display apparatus including 25 multi views according to directions as an embodiment of the present invention. At this time, the lens unit 195 may be a lenticular lens or a slit array.

As described above, if the lens unit 195 is inclined, as shown in FIG. 13, a red subpixel configuring a sixth view image appears at an interval of five pixels in horizontal and vertical directions and horizontal and vertical resolutions may be reduced to ⅕ the vertical resolution of the per-direction multi-view images before rearranging the stereoscopic image (3D image). Accordingly, as compared to the conventional method of reducing only horizontal resolution to 1/25, resolution is uniformly degraded in both directions.

FIG. 14 is a diagram illustrating a sweet zone and a dead zone which appear on a front surface of an image display apparatus.

If a stereoscopic image is viewed using the above-described image display apparatus 100, plural viewers who do not wear special stereoscopic glasses may perceive the stereoscopic effect, but a region in which the stereoscopic effect is perceived is limited.

There is a region in which a viewer may view an optimal image, which may be defined by an optimum viewing distance (OVD) D and a sweet zone 1020. First, the OVD D may be determined by a disparity between a left eye and a right eye, a pitch of a lens unit and a focal length of a lens.

The sweet zone 1020 refers to a region in which a plurality of view regions is sequentially located to enable a viewer to ideally perceive the stereoscopic effect. As shown in FIG. 14, if the viewer is located in the sweet zone 1020 (a), a right eye 1001 views twelfth to fourteenth view images and a left eye 1002 views seventeenth to nineteenth view images such that the left eye 1002 and the right eye 1001 sequentially view the per-direction view images. Accordingly, as described with reference to FIG. 12, the stereoscopic effect may be perceived through the left eye image and the right eye image.

In contrast, if the viewer is not located in the sweet zone 1020 but is located in the dead zone 1015 (b), for example, a left eye 1003 views first to third view images and a right eye 1004 views 23^{rd} to 25^{th} view images such that the left eye 1003 and the right eye 1004 do not sequentially view the per-direction view images and the left-eye image and the right-eye image may be reversed such that the stereoscopic effect is not perceived. In addition, if the left eye 1003 or the right eye 1004 simultaneously view the first view image and the 25^{th} view image, the viewer may feel dizzy.

The size of the sweet zone 1020 may be determined by the number n of per-direction multi-view images and a distance corresponding to one view. Since the distance corresponding to one view must be smaller than a distance between both eyes of a viewer, there is a limitation in distance increase. Thus, in order to increase the size of the sweet zone 1020, the number n of per-direction multi-view images is preferably increased.

FIGS. 15a and 15b are views referred to for describing a user gesture recognition principle.

FIG. 15A shows the case in which a user 500 makes a gesture of raising a right hand while viewing a broadcast image 1510 of a specific channel via the image display apparatus 100.

The camera unit 190 of the image display apparatus 100 captures an image of the user. FIG. 15B shows the image 1520 captured using the camera unit 190. The image 1520 captured when the user makes the gesture of raising the right hand is shown.

The camera unit 190 may continuously capture the image of the user. The captured image is input to the controller 170 of the image display apparatus 100.

The controller 170 of the image display apparatus 100 may receive an image before the user raises the right hand via the camera unit 190. In this case, the controller 170 of the image display apparatus 170 may determine that no gesture is input. At this time, the controller 170 of the image display apparatus 100 may perceive only the face (1515 of FIG. 15B) of the user.

Next, the controller 170 of the image display apparatus 100 may receive the image 1520 captured when the user makes the gesture of raising the right hand as shown in FIG. 15B.

In this case, the controller 170 of the image display apparatus 100 may measure a distance between the face (1515 of FIG. 15B) of the user and the right hand 1505 of the user and determine whether the measured distance D1 is equal to or less than a reference distance Dref. If the measured distance D1 is equal to or less than the reference distance Dref, a predetermined first hand gesture may be recognized.

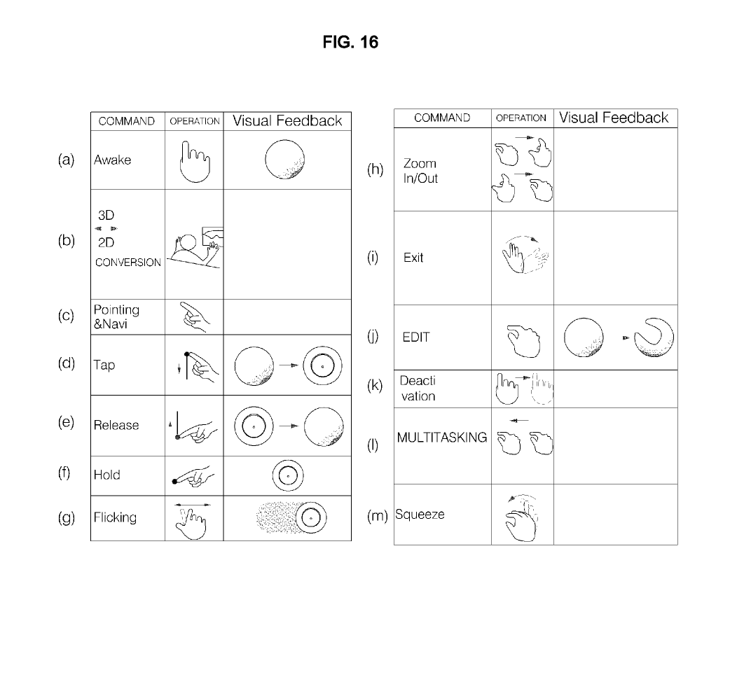

FIG. 16 shows operations corresponding to user gestures. FIG. 16(a) shows an awake gesture corresponding to the case in which a user points one finger for N seconds. Then, a circular object may be displayed on a screen and brightness may be changed until the awake gesture is recognized.

Next, FIG. 16(b) shows a gesture of converting a 3D image into a 2D image or converting a 2D image into a 3D image, which corresponds to the case in which a user raises both hands to a shoulder height for N seconds. At this time, depth may be adjusted according to the position of the hand. For example, if both hands move toward the display 180, the depth of the 3D image may be decreased, that is, the 3D image reduced and, if both hands move in the opposite direction of the display 180, the depth of the 3D image may be increased, that is, the 3D image expanded, and vice versa. Conversion completion or depth adjustment completion may be signaled by a clenched fist. Upon a gesture of FIG. 16(b), a glow effect in which an edge of the screen is shaken while a displayed image is slightly lifted up may be generated. Even during depth adjustment, a semi-transparent plate may be separately displayed to provide the stereoscopic effect.

Next, FIG. 16(c) shows a pointing and navigation gesture, which corresponds to the case in which a user relaxes and inclines his/her wrist at 45 degrees in a direction of an XY axis.

Next, FIG. 16(d) shows a tap gesture, which corresponds to the case in which a user unfolds and slightly lowers one finger in a Y axis within N seconds. Then, a circular object is displayed on a screen. Upon tapping, the circular object may be enlarged or the center thereof may be depressed.

Next, FIG. 16(e) shows a release gesture, which corresponds to the case in which a user raises one finger in a Y axis within N seconds in a state of unfolding one finger. Then, a circular object modified upon tapping may be restored on the screen.

Next, FIG. 16(f) shows a hold gesture, which corresponds to the case in which tapping is held for N seconds. Then, the object modified upon tapping may be continuously held on the screen.

Next, FIG. 16(g) shows a flick gesture, which corresponds to the case in which the end of one finger rapidly moves by N cm in an X/Y axis in a pointing operation. Then, a residual image of the circular object may be displayed in a flicking direction.

Next, FIG. 16(h) shows a zoom-in or zoom-out gesture, wherein a zoom-in gesture corresponds to a pinch-out gesture of spreading a thumb and an index finger and a zoom-out gesture corresponds to a pinch-in gesture of pinching a thumb and an index finger. Thus, the screen may be zoomed in or out.

Next, FIG. 16(i) shows an exit gesture, which corresponds to the case in which the back of a hand is swiped from the left to the right in a state in which all fingers are unfolded. Thus, the OSD on the screen may disappear.

Next, FIG. 16(j) shows an edit gesture, which corresponds to the case in which a pinch operation is performed for N seconds or more. Thus, the object on the screen may be modified to feel as if the object is pinched.

Next, FIG. 16(k) shows a deactivation gesture, which corresponds to an operation of lowering a finger or a hand. Thus, the hand-shaped pointer may disappear.

Next, FIG. 16(l) shows a multitasking gesture, which corresponds to an operation of moving the pointer to the edge of the screen and sliding the pointer from the right to the left in a pinched state. Thus, a portion of the edge of a right lower end of the displayed screen is lifted up as would be a piece of paper. Upon selection of a multitasking operation, a screen may be turned as if pages of a book are turned.

Next, FIG. 16(m) shows a squeeze gesture, which corresponds to an operation of folding all five unfolded fingers. Thus, icons/thumbnails on the screen may be collected or only selected icons may be collected upon selection.

FIG. 16 shows examples of the gesture and various additional gestures or other gestures may be defined.

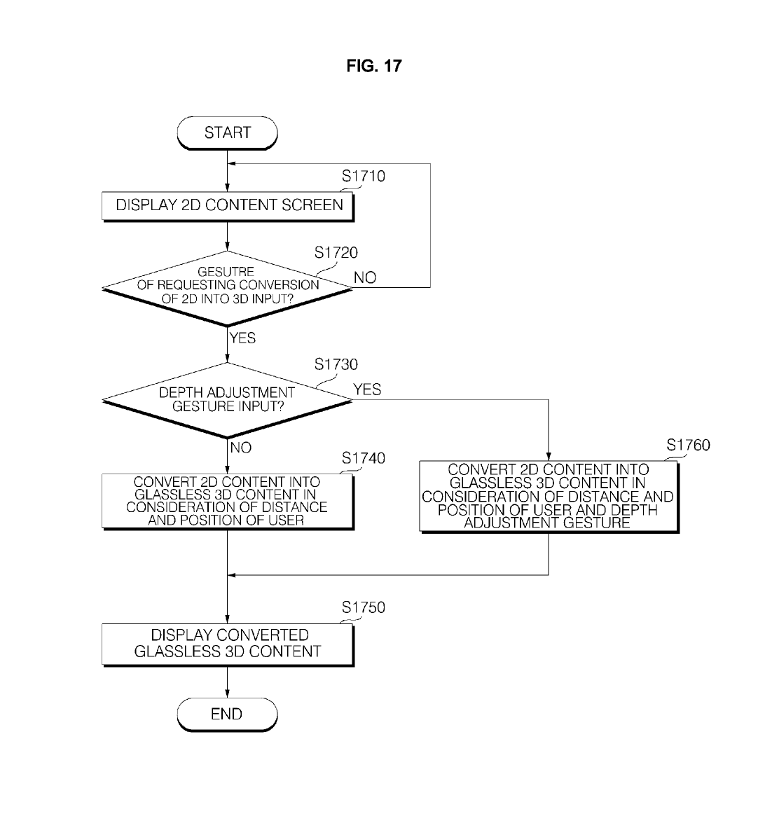

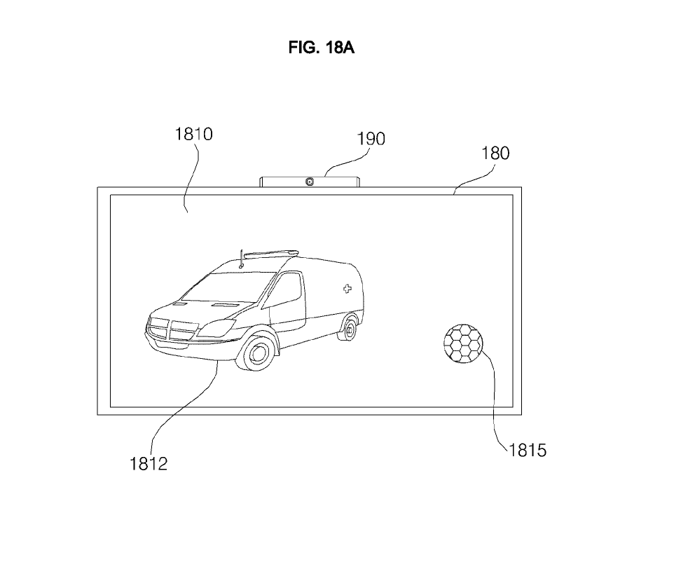

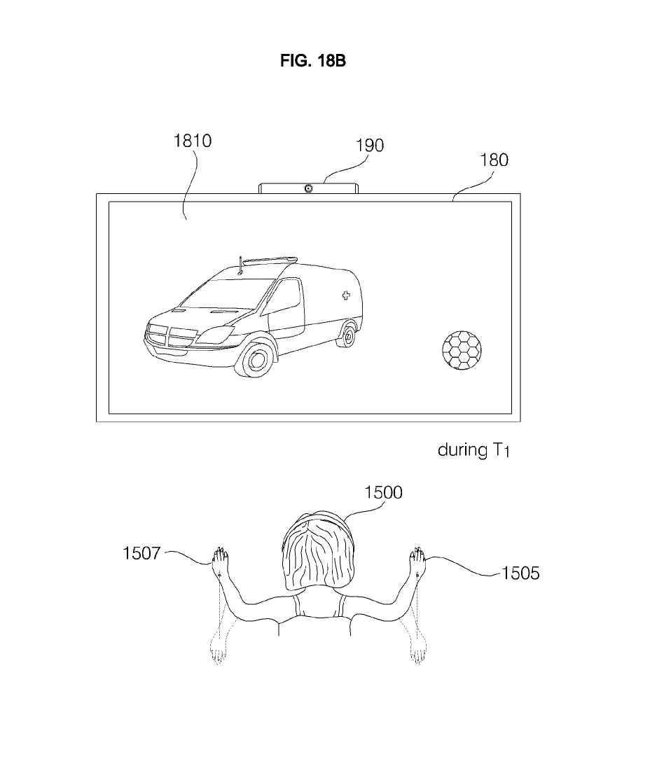

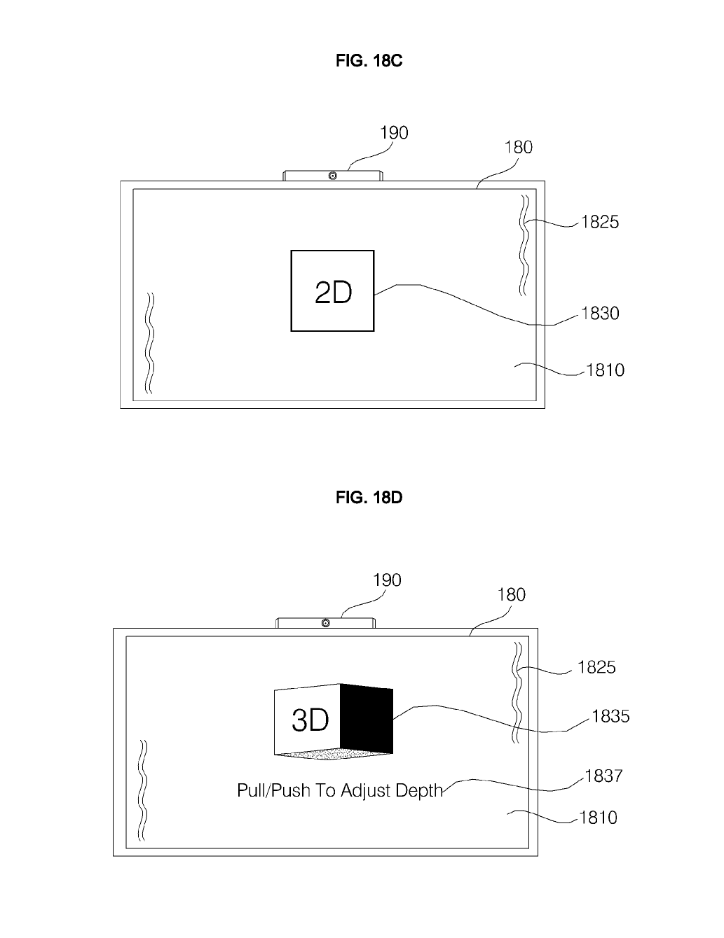

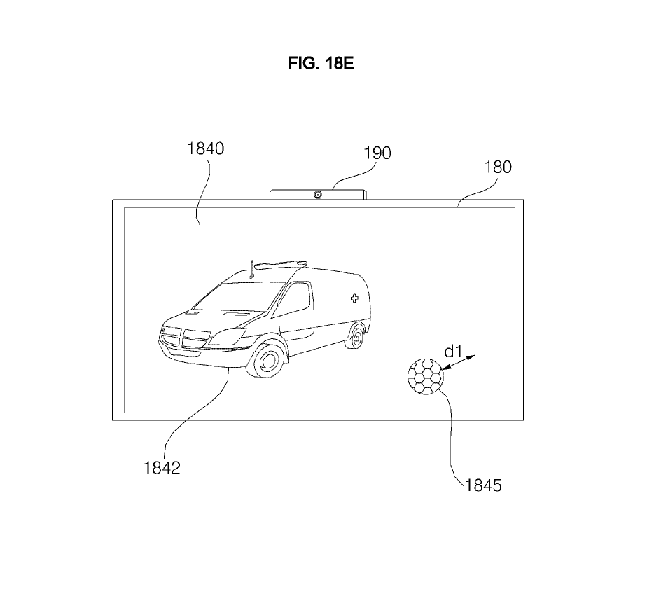

FIG. 17 is a flowchart illustrating a method for operating an image display apparatus according to an embodiment of the present invention, and FIGS. 18a to 26 are views referred to for describing various examples of the method for operating the image display apparatus of FIG. 17.

First, referring to FIG. 17, the display 180 of the image display apparatus 100 displays a 2D content screen (S1710).

The displayed 2D content screen may be an external input image such as a broadcast image or an image stored in the memory 140. The controller 170 controls display of 2D content in correspondence with predetermined 2D content display input of a user.

FIG. 18A shows display of a 2D content screen 1810. The 2D content screen 1810 may include a 2D object 1812 and a 2D object 1815. The 2D object 1812 and the 2D object 1815 may have the same depth value 0.

Next, the controller 170 of the image display apparatus 100 determines whether a gesture of converting 2D content into 3D content (S1720) is input. If so, step 1730 (S1730) is performed. That is, the controller 170 of the image display apparatus determines whether a depth adjustment gesture is input (S1730). If not, the 2D content is converted into glassless 3D content in consideration of the distance and position of the user (S1740). Then, the converted glassless 3D content is displayed (S1750).

The camera unit 190 of the image display apparatus captures the image of the user and sends the captured image to the controller 170. The controller 170 recognizes the user and senses a user gesture as described with reference to FIGS. 15a to 15b.

FIG. 18B shows the case in which the user makes a gesture of raising both hands to a shoulder height for a predetermined time T1 while viewing the 2D content screen 1810.

The controller 170 may recognize the gesture of raising both hands 1605 and 1507 to the shoulder height through the captured image. As described with reference to FIG. 16(b), since the gesture of raising both hands to the shoulder height corresponds to a gesture of converting a 2D image into a 3D image, the controller 170 may recognize a gesture of converting a 2D image into a 3D image.

The controller 170 converts the 2D content into 3D content.

For example, the controller 170 splits the 2D content into a left-eye image and a right-eye image using a depth map if there is a depth map for the 2D content. The left-eye image and the right-eye image are arranged in a predetermined format.

In the embodiment of the present invention, since the glassless method is used, the controller 170 calculates the position and distance of the user using the image of the face and hand of the user captured by the camera unit 190. Per-direction multi-view images including the left-eye image and the right-eye image are arranged according to the calculated position and distance of the user.

As another example, if there is no depth map for the 2D content, the controller 170 extracts the depth map from the 2D content using an edge detection technique. As described above, the 2D content is split into a left-eye image and a right-eye image and per-direction multi-view images including the left-eye image and the right-eye image are arranged according to the calculated position and distance of the user.

Such a conversion process consumes a predetermined time and thus an object indicating which conversion is being performed may be displayed. Therefore, it is possible to increase user convenience.

FIG. 18C shows display of an object 1830 indicating that displayed content is 2D content at the center of the display 180 upon initial conversion. At this time, a portion 1825 of an edge or corner of a displayed 2D content screen may be shaken as shown. Therefore, the glow effect may be generated. Thus, the user may intuitively perceive that conversion is being performed.

Next, FIG. 18D shows display of an object 1835 indicating that 2D content is being converted into 3D content. At this time, the portion 1825 of the edge or corner of the screen may continue to be shaken as shown.

FIG. 18D shows display of text 1837 indicating additional input for depth adjustment of the converted 3D content. Through such text, the user may perform depth adjustment of the converted 3D content.

If there is no gesture other than the gesture of raising both hands, the 3D content may be converted without depth adjustment of 3D content.

FIG. 18E shows display of a 3D content screen 1840 converted without the depth adjustment gesture of the user. At this time, the second object 1845 between the first and the second object 1842 and 1845 is a 3D object having a predetermined depth d1. In this way, it is possible to conveniently convert 2D content into 3D content and to increase user convenience.

In step 1730 (S1730), if the user inputs a depth adjust gesture, the controller 170 converts 2D content into glassless 3D content in consideration of the distance, position and depth adjustment gesture of the user (S1760). Then, the converted glassless 3D content is displayed (S1750).

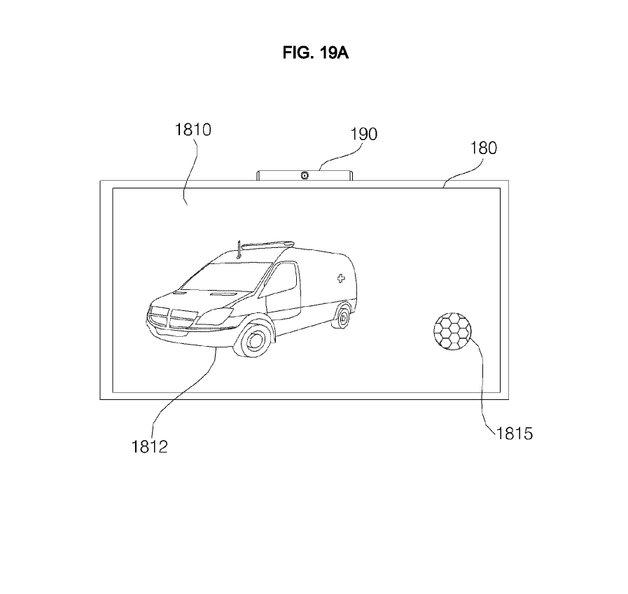

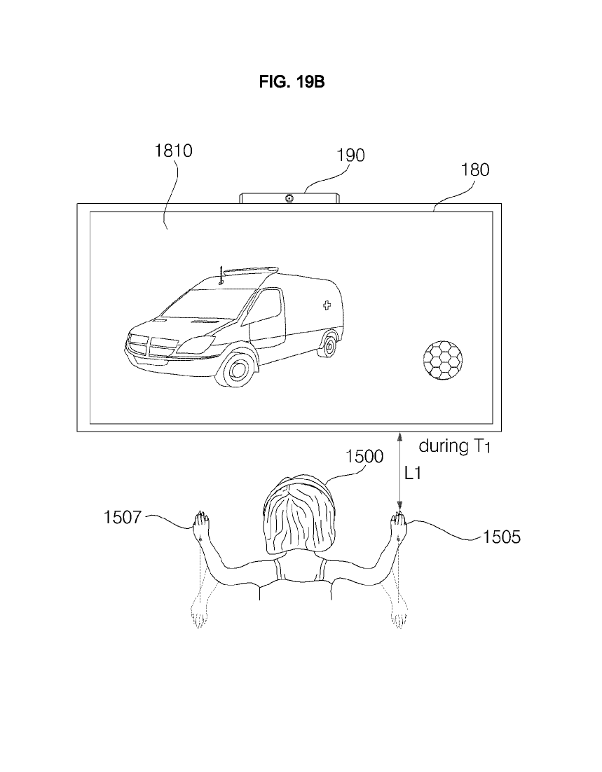

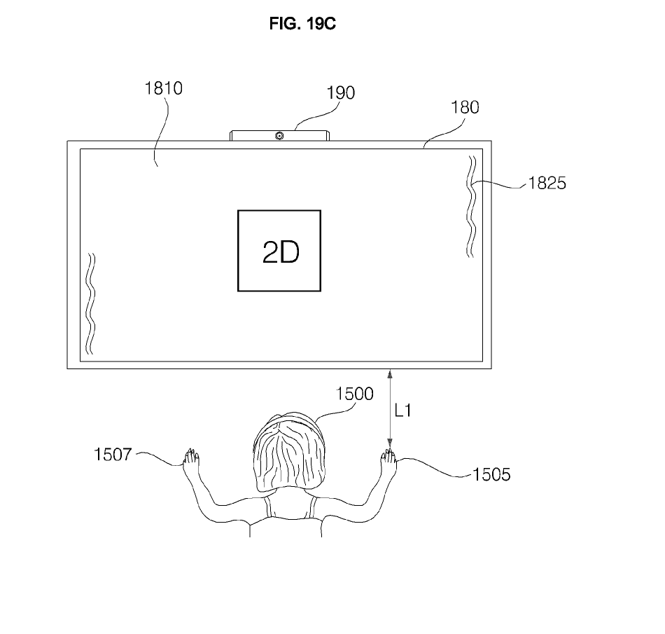

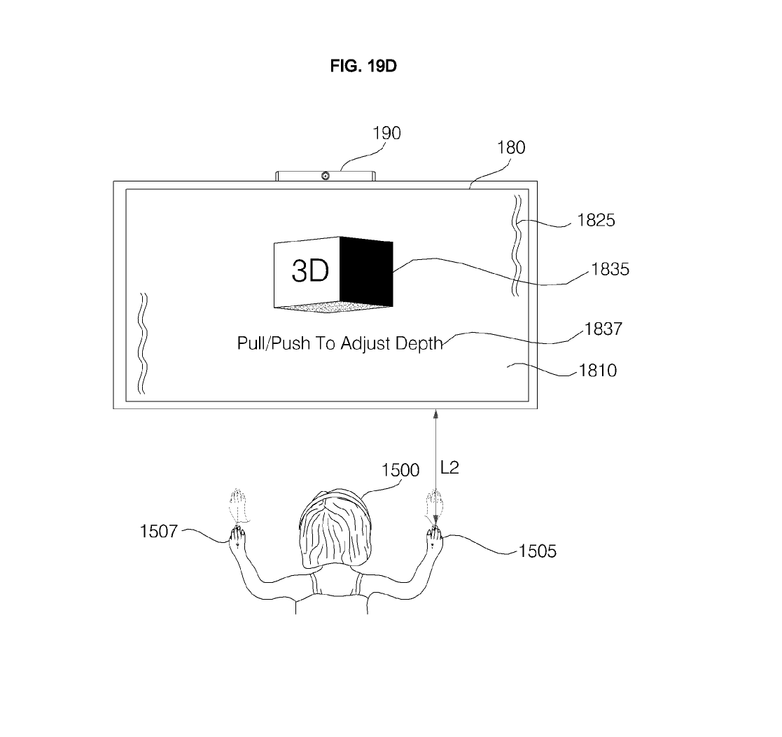

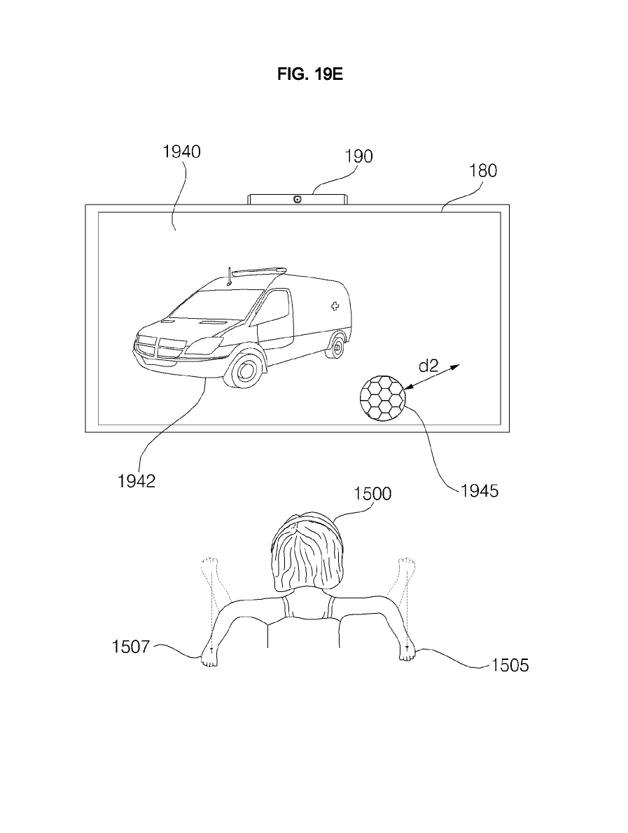

FIGS. 19a to 19d show an example of adjusting depth according to a depth adjustment gesture while 2D content is converted into 3D content.

FIGS. 19a to 19c correspond to FIGS. 18a to 18c. Referring to FIG. 19C, a distance L1 between the right hand 1501 of the user and the display 180 is L1 when the user makes a gesture of raising both hands.

FIG. 19d shows display of an object 1835 indicating that 2D content is being converted into 3D content. At this time, the portion 1825 of the edge or corner of the screen may be shaken as shown. FIG. 19d shows display of text 1837 indicating additional input for adjusting the depth of converted 3D content.

At this time, if the user moves both hands to a location L2 farther from the display 180 than a location L1, the controller 170 may recognize such movement as a depth adjustment gesture via a captured image. In particular, the controller 170 may recognize a gesture of increasing the depth of the 3D content such that the user perceives the 3D content as protruding.

Accordingly, the controller 170 further increases the depth of the converted 3D content. FIG. 19e shows a screen 1940 on which 3D content, the depth of which is adjusted by the depth adjustment gesture of the user, is displayed. The depth D2 of the second object 1945 between the first and second objects 1942 and 1945 is increased as compared to FIG. 18E. In this way, it is possible to conveniently convert 2D content into 3D content via a user gesture, to perform depth adjustment, and to increase user convenience.

FIG. 19e shows a state in which the user lowers both hands. This may be recognized as a gesture to end conversion into 3D content.

When a gesture of raising both hands is input while viewing a 3D content screen, conversion into 2D content may be performed.

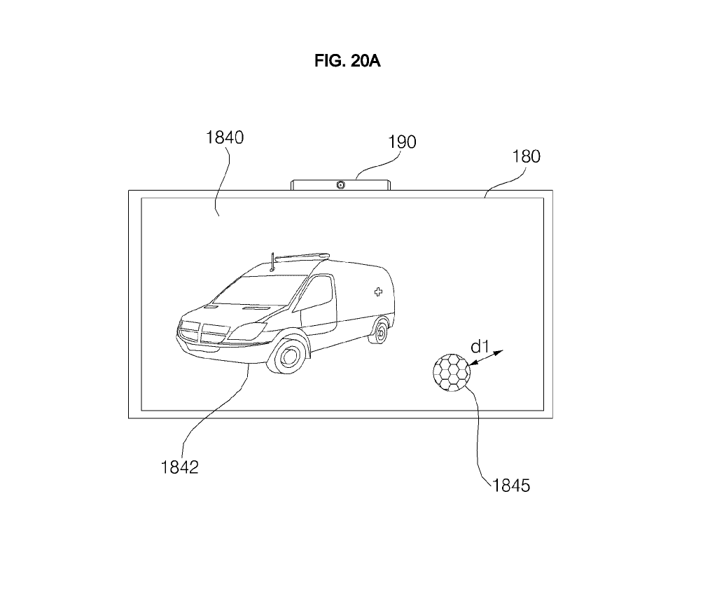

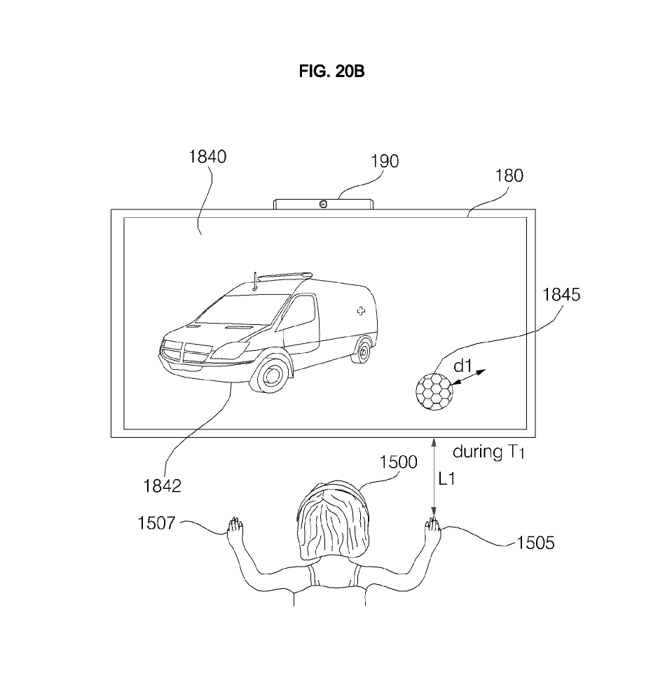

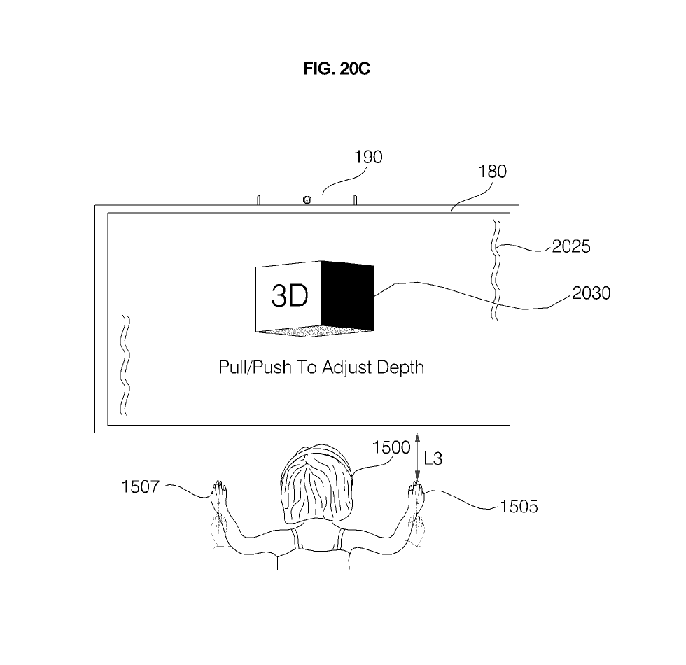

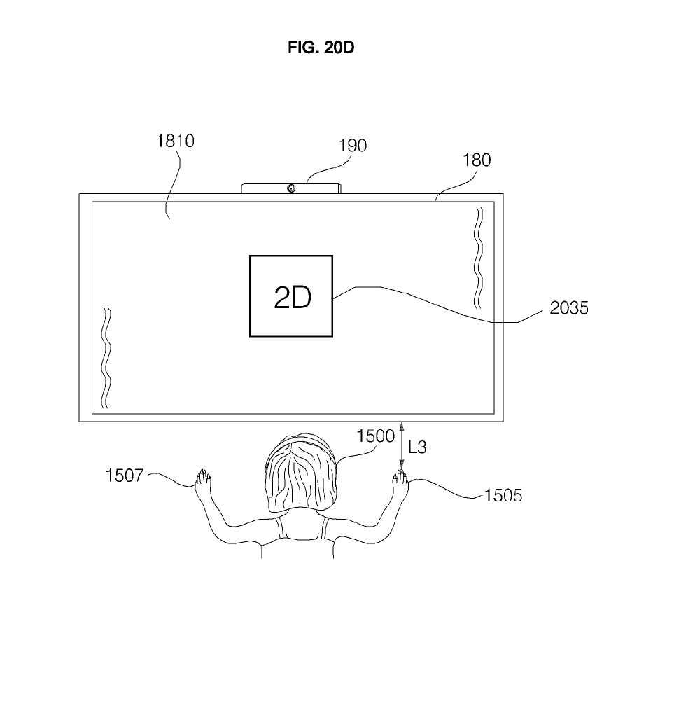

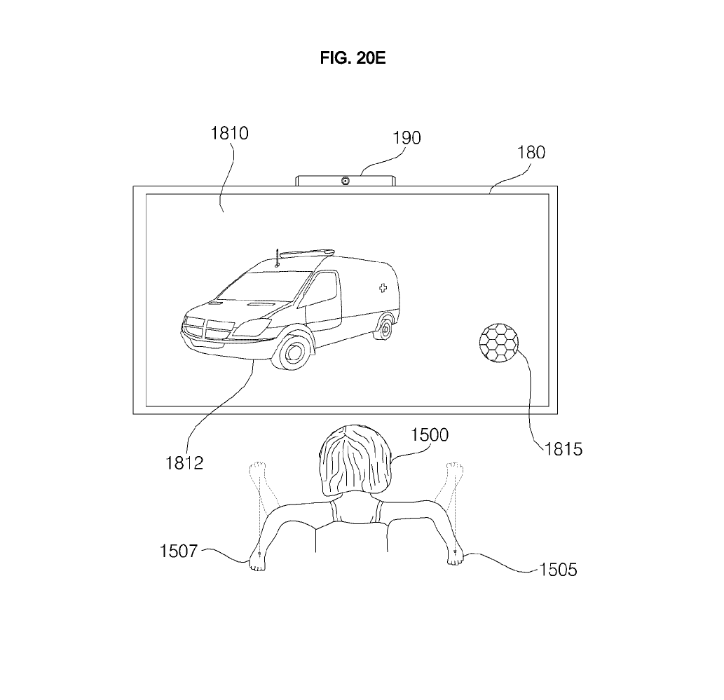

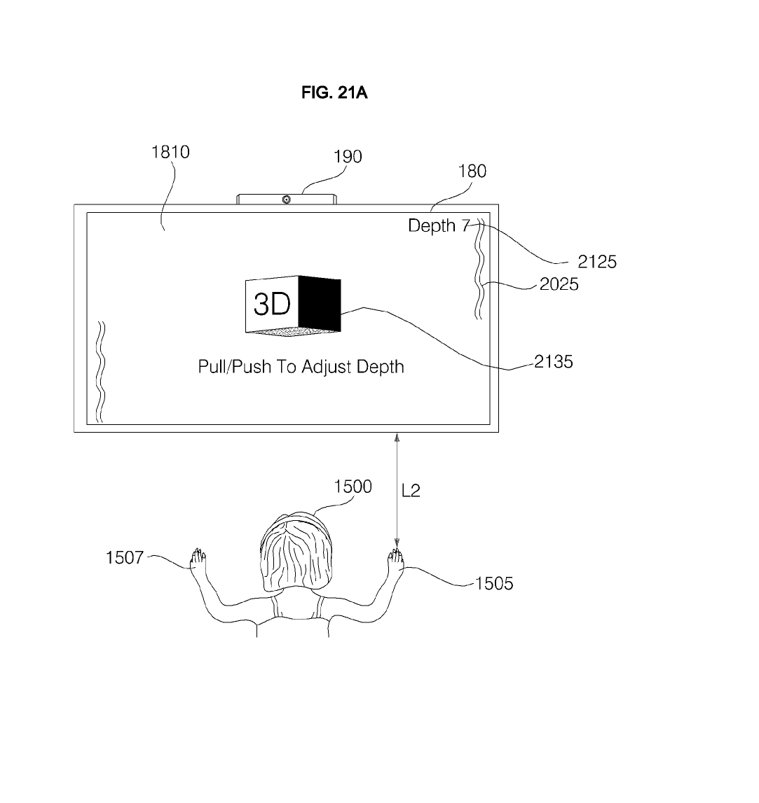

FIGS. 20a to 20d show an example of converting 3D content into 2D content.

FIG. 20a shows display of the 3D content screen 1840 including the first and second objects 1842 and 1845 on the image display apparatus 100. At this time, the second object 1845 is a 3D object having a depth d1.

Next, FIG. 20B shows a state in which the user makes a gesture of raising both hands to a shoulder height for a predetermined time T1 while viewing the 3D content screen 1840.

The controller 170 may recognize a gesture of converting a 3D image into a 2D image as described with reference to FIG. 16(b).

Referring to FIG. 20B, a distance between the right hand 1505 of the user and the display 180 when the user makes a gesture of raising both hands is L1.

FIG. 20C shows display of an object 2030 indicating that displayed content is 3D content at the center of the display 180 upon initial conversion. At this time, the portion 2025 of the edge or corner of the displayed 3D content screen may be shaken as shown. Therefore, the glow effect may be generated. Thus, the user may intuitively perceive that conversion is being performed.

FIG. 20C shows display of text indicating additional input for depth adjustment.

At this time, if the user moves both hands to a location L3 closer to the display 180 than the location L1, the controller 170 may recognize such movement as a depth adjustment gesture via a captured image. In particular, the controller 170 may recognize a gesture of decreasing the depth of the 3D content such that the user perceives the 3D content as being depressed. By such a gesture, the depth of the 3D object becomes 0 and, as a result, the 3C content may be converted into 2D content.

FIG. 20d shows display of an object 2035 indicating that converted content is 2D content at the center of the display 180 during conversion. At this time, the portion of the edge or corner of the screen may be shaken as shown. Therefore, the glow effect may be generated. Thus, the user may intuitively perceive that conversion is being performed.

Next, FIG. 20e shows display of a 2D content screen 1810 after 3D content is converted into 2D content. That is, the depths of the objects 1812 and 1815 on the 2D content screen 1810 are 0. In this way, it is possible to conveniently convert 3D content into 2D content via a user gesture and to increase user convenience.

Upon conversion of 3D content into 2D content, 3D content may be converted into 2D content via the gesture of FIG. 20B without the depth adjustment gesture shown in FIG. 20C.

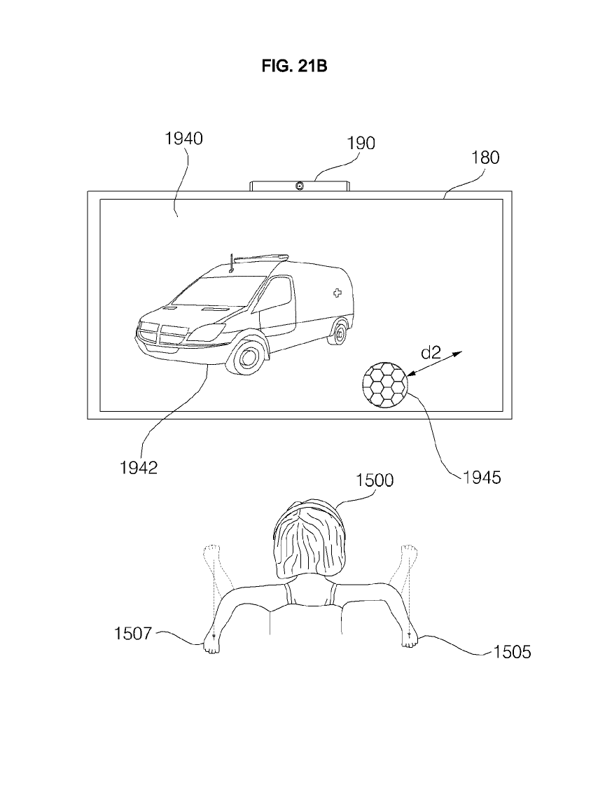

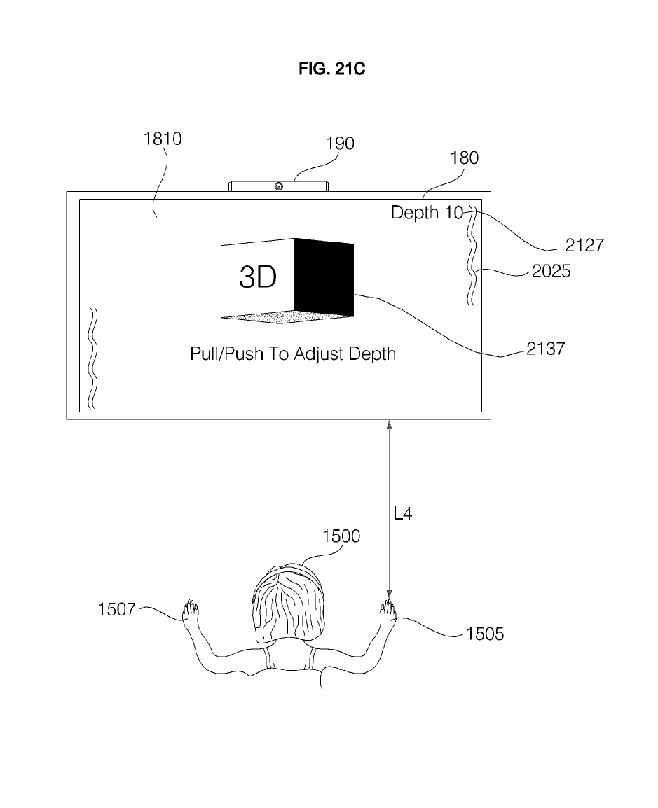

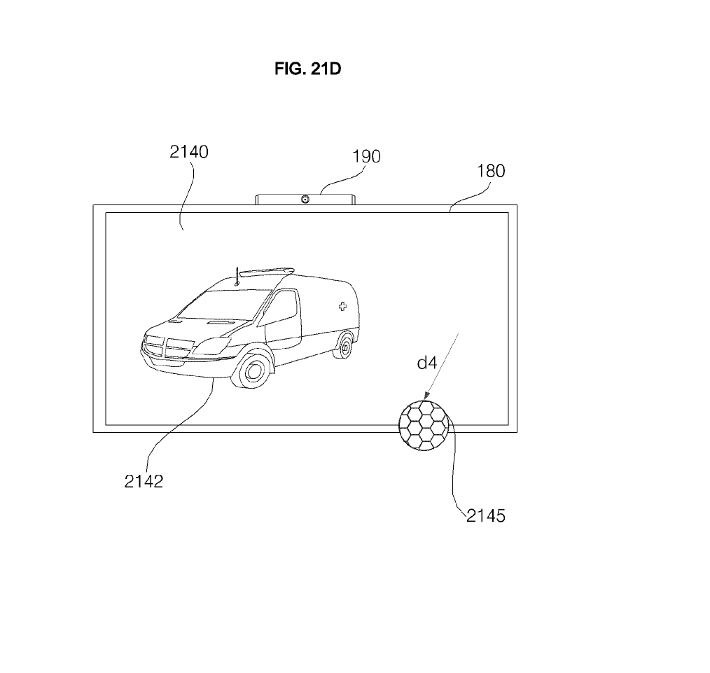

FIGS. 21a to 21d show the case in which the depth is changed according to the distance between the user and the display upon converting 2D content into 3D content.

FIG. 21a shows a state in which the user converts 2D content into 3D content via a gesture of raising both hands. At this time, a portion 2025 of the edge or corner of the displayed 3D content screen may be shaken as shown.

Referring to FIG. 21a, the distance between the user 1500 and the display 180 is L2. FIG. 21a shows an object 2125 indicating the depth of the converted 3D content.

Thus, the controller 170 may set the depth in consideration of the distance L2 between the user 1500 and the display 180 upon 3D content conversion.

That is, FIG. 21B shows a converted 3D content screen 1940. At this time, the second object 1945 between the first and second objects 1942 and 1945 has the depth d2.

FIG. 21C shows the state in which the user converts 2D content into 3D content via a gesture of raising both hand. At this time, the portion 2025 of the edge or corner of the displayed 3D content screen may be shaken as shown.

Referring to FIG. 21C, the distance between the user 1500 and the display 180 is L4. FIG. 21C shows an object 2127 indicating the depth of the converted 3D content.

Accordingly, the controller 170 may set a depth in consideration of the distance L4 between the user 1500 and the display 180 upon 3D content conversion.

That is, FIG. 21d shows a converted 3D content screen 2140. At this time, the second object 2145 between the first and second objects 2142 and 2145 has a depth d4.

That is, when comparing FIG. 21d with FIG. 21B, the depth of the converted 3D content is increased. Thus, a user who is located farther from the screen may perceive a greater depth.

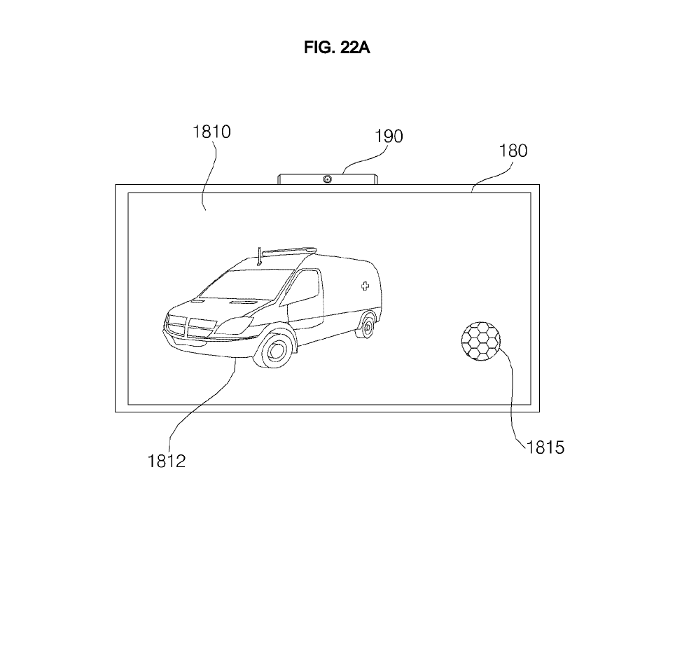

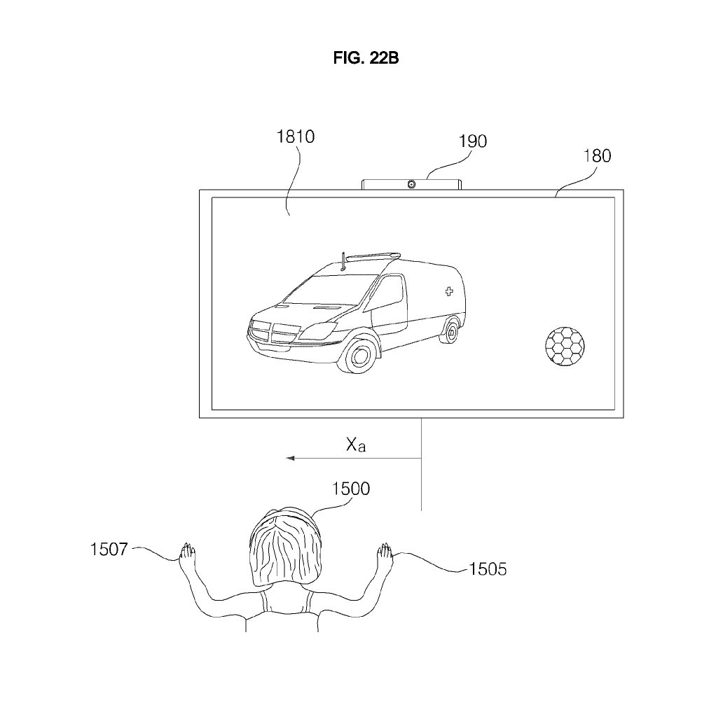

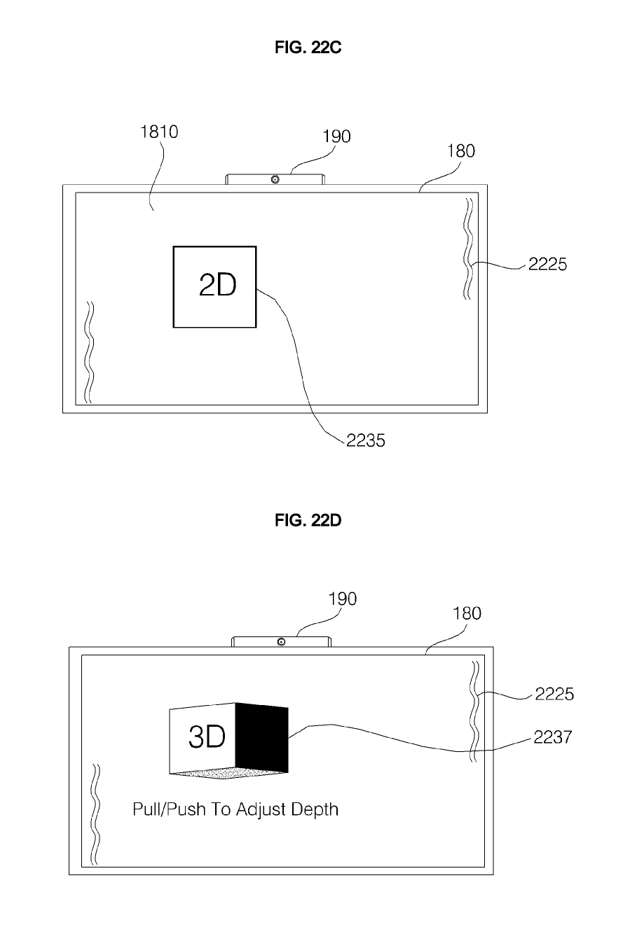

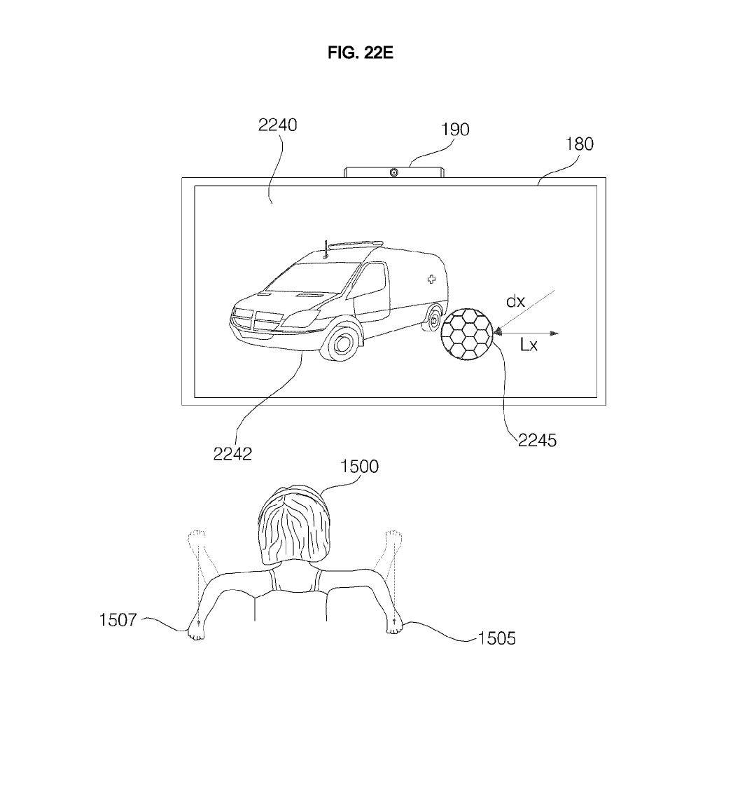

FIGS. 22a to 22d show a state in which a displayed 3D content screen is changed according to the position of the user upon conversion from 2D content into 3D content.

FIG. 22a shows display of a 2D content screen 1810 on a display as shown in FIG. 18A.

FIG. 22B shows a state in which the user makes a gesture of raising both hands to a shoulder height during a predetermined time T1 while viewing the 2D content screen 1810. At this time, the position of the user is shifted to the left by Xa as compared to FIG. 18B.

FIG. 22C shows display of an object 2235 indicating that the displayed content is 2D content in the left region of the display 180 upon initial conversion. At this time, the portion 2225 of the edge or corner of the displayed 2D content screen may be shaken as shown. Therefore, the glow effect may be generated. Thus, the user may intuitively perceive that conversion is being performed.

Next, FIG. 22d shows display of an object 2237 indicating that 2D content is being converted into 3D content in the left region of the display 180. At this time, a portion 2225 of the edge of the screen may continue to be shaken as shown.

FIG. 22e shows display of a 3D content screen 2240 converted without a depth adjustment gesture of a user. At this time, the second object 2245 between the first and second objects 2242 and 2245 is a 3D object having a predetermined depth dx. As compared to FIG. 18E, the position of the second object is shifted to the left by lx. Since 3D content is converted in consideration of the position of the user, it is possible to increase user convenience.

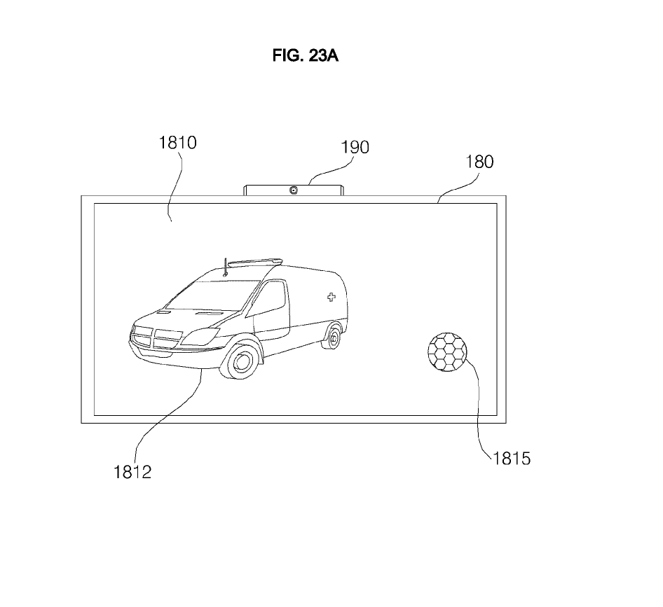

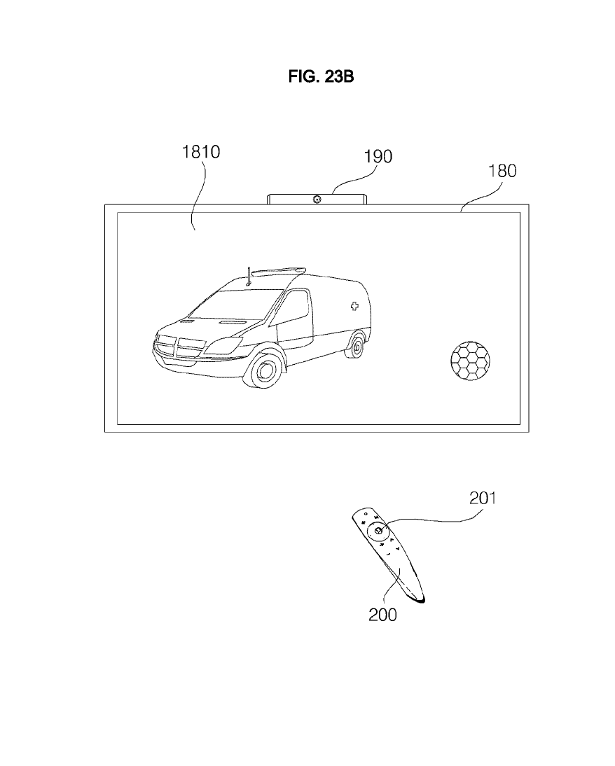

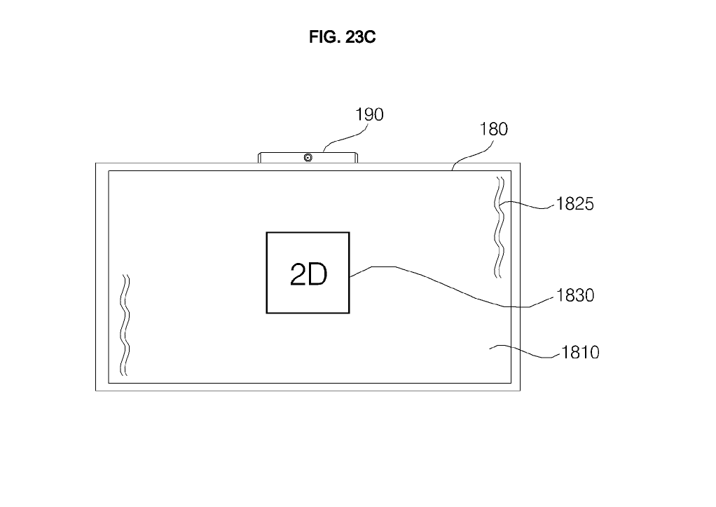

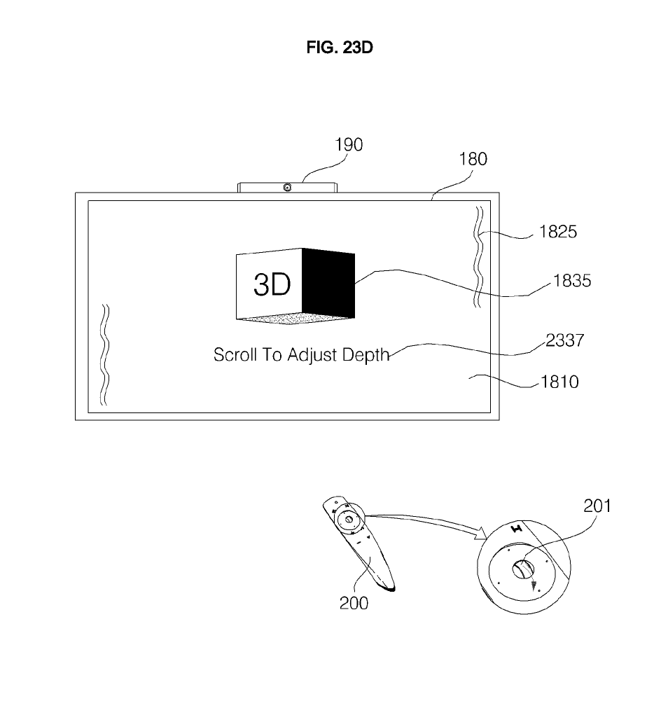

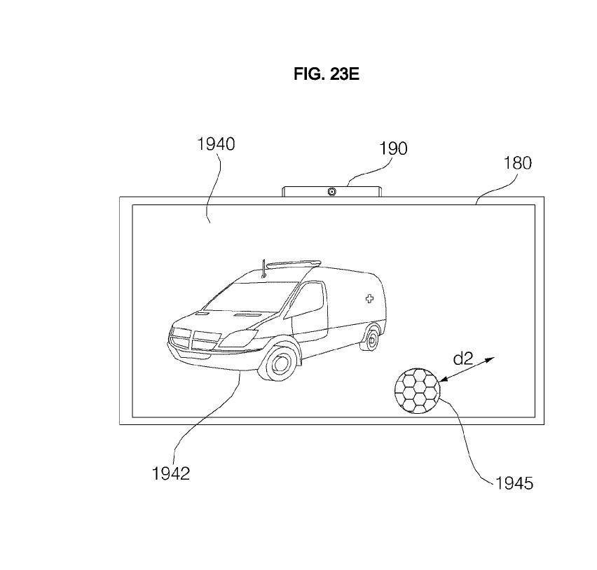

FIGS. 23a to 23e show conversion from 2D content into 3D content using a remote controller.

FIG. 23a shows a 2D content screen 1810 displayed on the display. The 2D content screen 1810 may include a 2D object 1812 and a 2D object 1815.

FIG. 23B shows the state in which the user presses a scroll key 201 of the remote controller 200 while viewing the 2D content screen 1810.

The controller 170 may receive and recognize an input signal of the scroll key 201 as an input signal for converting a 2D image into a 3D image. Then, the controller 170 converts 2D content into 3D content.

Such a conversion process consumes a predetermined time and thus an object indicating that conversion is being performed may be displayed. Therefore, it is possible to increase user convenience.

FIG. 23C shows display of an object 1830 indicating that displayed content is 2D content at the center of the display 180 upon initial conversion. At this time, the portion 1825 of the edge or corner of the displayed 2D content screen may be shaken as shown. Therefore, the glow effect may be generated. Thus, the user may intuitively perceive that conversion is being performed.

Next, FIG. 23d shows display of an object 1835 indicating that 2D content is being converted into 3D content. At this time, the portion 1825 of the edge or corner of the screen may continue to be shaken as shown.

FIG. 18D shows display of text 2337 indicating additional input for depth adjustment of the converted 3D content. Through such text, the user may immediately adjust the depth of the converted 3D content.

For example, if the scroll key 201 of the remote controller 200 is scrolled, depth adjustment may be performed. The depth may be decreased upon upward scrolling and increased upon downward scrolling.

For example, if the scroll key is scrolled downward, the controller 170 further increases the depth of the converted 3D content.

FIG. 23e shows display of a 3D content screen 1940 in which the depth of the 3D content is changed by scrolling the scroll key downward. At this time, the depth d2 of the second object 1945 between the first and second objects 1942 and 1945 is increased as compared to FIG. 18E. It is possible to conveniently convert 2D content into 3D content via the remote controller 200, to perform depth adjustment, and to increase user convenience.

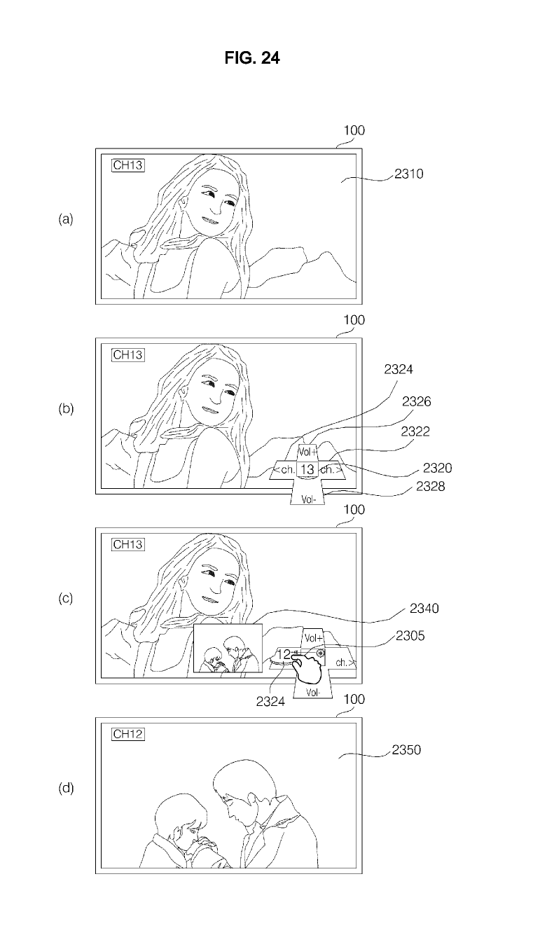

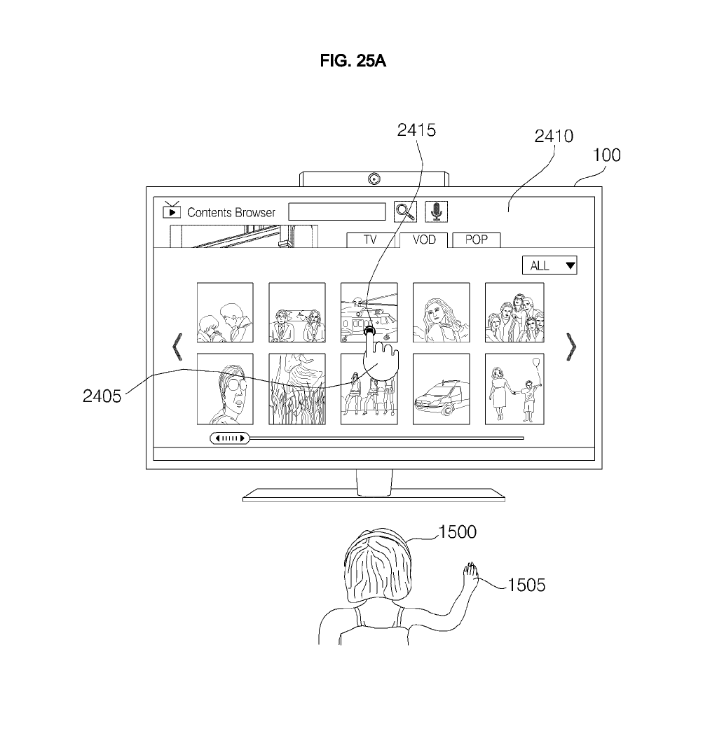

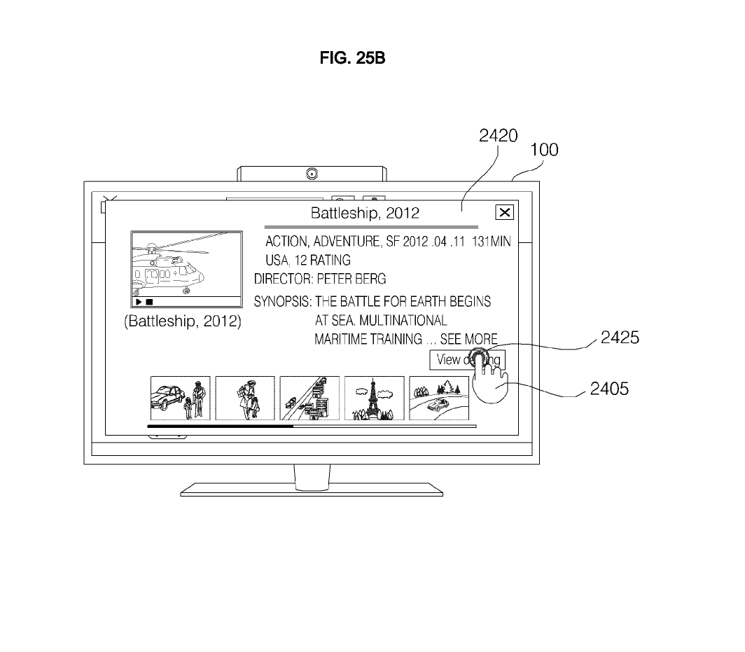

FIG. 24 shows channel change or volume change based on a user gesture.

First, FIG. 24(a) shows display of a predetermined content screen 2310. The predetermined content screen 2310 may be a 2D image or a 3D image.

Next, if predetermined user input is performed, an object 2320 capable of changing channels or volume may be displayed while viewing content 2310 as shown in FIG. 24(b). This object may be generated by the image display apparatus and may be referred to as an OSD 2320.

Predetermined user input may be voice input, button input of a remote controller or user gesture input.

The depth of the displayed OSD 2320 may be set to a largest value or the position of the displayed OSD 2320 may be adjusted in order to improve readability.

The displayed OSD 2320 includes channel control items 2322 and 2324 and volume control items 2326 and 2328. The OSD 2320 is displayed in 3D.

Next, FIG. 24(c) shows the case in which a lower channel item 2324 of the channel control item is selected by a predetermined user gesture. Then, a preview screen 2640 may be displayed on the screen.

The controller 170 may control execution of operations corresponding to the predetermined user gesture.

The gesture of FIG. 24(c) may be the pointing and navigation gesture shown in FIG. 16(c).

FIG. 24(d) shows display of a channel screen 2350 changed to a lower channel by the predetermined user gesture. At this time, the user gesture may be the tap gesture shown in FIG. 16(d).

Therefore, the user may conveniently perform channel control or volume control.

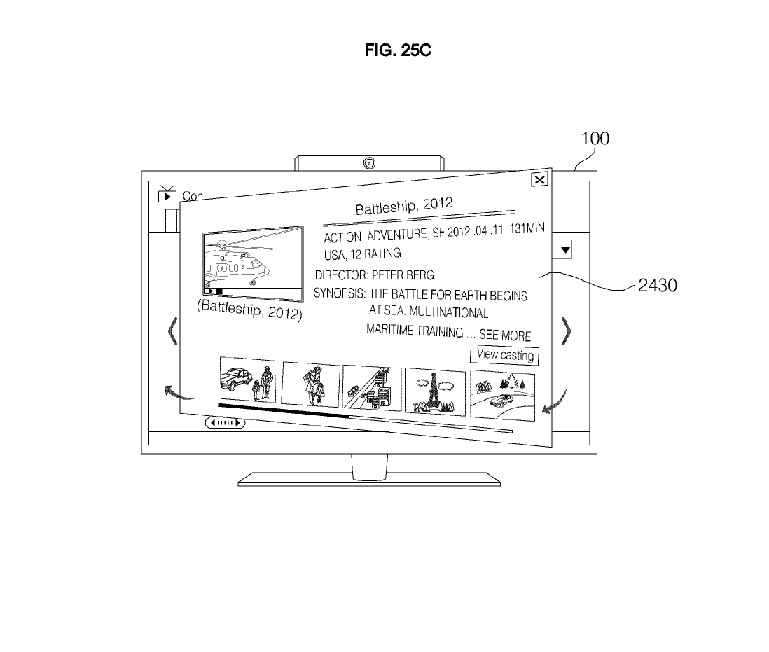

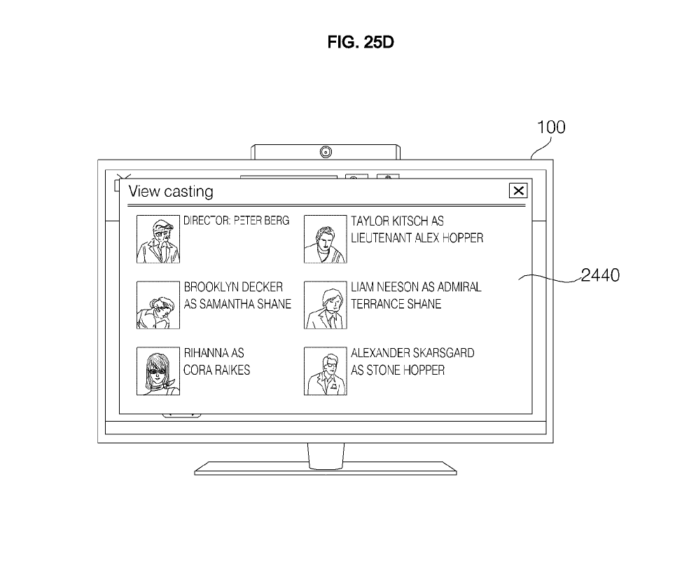

FIGS. 25a to 25c show another example of screen switching by a user gesture.

FIG. 25a shows display of a content list 2410 on the image display apparatus 100. If the tap gesture of FIG. 16(d) is performed using the right hand 1505 of the user 1500, an item 2415 in which the hand-shaped pointer 2405 is located may be selected.

Then, a content screen 2420 shown in FIG. 25B may be displayed. At this time, if the tap gesture of FIG. 16(d) is made using the right hand 1505 of the user 1500, an item 2425 in which the hand-shaped pointer 2405 is located may be selected.

In this case, as shown in FIG. 25C, a content screen 2430 may be temporarily displayed while a displayed content screen 2420 is rotated. As a result, as shown in FIG. 25d, the screen may be switched and thus a screen 2440 corresponding to the selected item 2425 may be displayed.

As shown in FIG. 25C, if the content screen 2430 is stereoscopically rotated, readability is increased. Thus, the user may concentrate more easily.

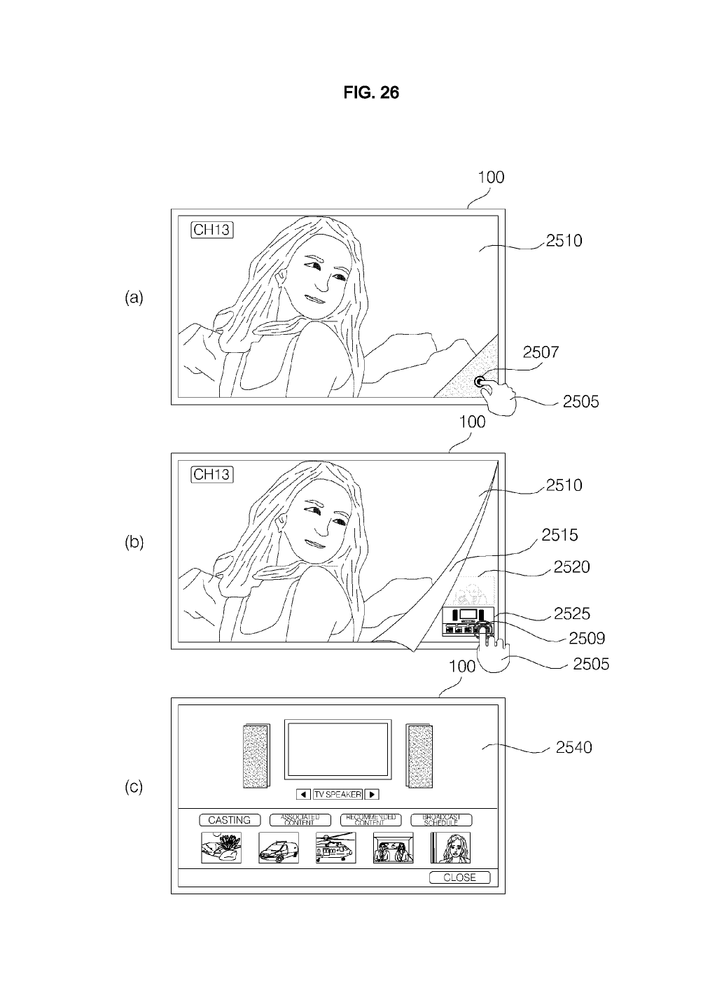

FIG. 26 illustrates gestures associated with multitasking.

FIG. 26(a) shows display of a predetermined image 2510. At this time, if the user makes a predetermined gesture, the controller 170 senses the user gesture.

If the gesture of FIG. 26(a) is the multitasking gesture of FIG. 16(1), that is, if the pointer 2505 is moved to the screen edge 2507 and then slides from the right to the left in a pinched state, as shown in FIG. 26(b), a portion of the edge of a right lower end of the displayed screen 2510 may be lifted up as through paper were being lifted, and a recent screen list 2525 may be displayed on a next surface 2520 thereof. That is, the screen may be turned as if pages of a book are turned.

If the user makes a predetermined gesture, that is, if a predetermined item 2509 of the recent execution screen list 2525 is selected, as shown in FIG. 26(c), a selected recent execution screen 2540 may be displayed. A gesture at this time may correspond to a tap gesture of FIG. 16(d).

As a result, the user may conveniently execute a desired operation without blocking the image viewed by the user.

The recent execution screen list 2525 is an OSD, which may have a greatest depth or may be displayed so as not to overlap another object.

According to an embodiment of the present invention, when a first hand gesture is input while an image display apparatus displays a 2D content screen, 2D content is converted into 3D content and the converted 3D content is displayed. Thus, it is possible to conveniently convert 2D content into 3D content. Accordingly, it is possible to increase user convenience.

When a second gesture associated with depth adjustment is input after the first hand gesture has been input, the depth of the 3D content is set based on the input second gesture and the 2D content is converted into 3D content based on the set depth. Thus, it is possible to easily set a depth desired by the user.

The position and distance of the user are sensed when the 2D convent is converted into 3D content, multi-view images of the converted 3D content are arranged and displayed based on at least one of the position and distance of the user, and images corresponding to the left eye and right eye of the user are output via the lens unit for splitting the multi-view images according to direction. Thus, the user can stably view a 3D image without glasses.

According to the embodiment of the present invention, the image display apparatus may recognize a user gesture based on an image captured by a camera and perform an operation corresponding to the recognized user gesture. Thus, user convenience is enhanced.

The image display apparatus and the method for operating the same according to the foregoing embodiments are not restricted to the embodiments set forth herein. Therefore, variations and combinations of the exemplary embodiments set forth herein may fall within the scope of the present invention.

The method for operating an image display apparatus according to the foregoing embodiments may be implemented as code that can be written to a computer-readable recording medium and can thus be read by a processor. The computer-readable recording medium may be any type of recording device in which data can be stored in a computer-readable manner. Examples of the computer-readable recording medium include a ROM, a RAM, a CD-ROM, a magnetic tape, a floppy disk, optical data storage, and a carrier wave (e.g., data transmission over the Internet). The computer-readable recording medium may be distributed over a plurality of computer systems connected to a network so that computer-readable code is written thereto and executed therefrom in a decentralized manner. Functional programs, code, and code segments to realize the embodiments herein can be construed by one of ordinary skill in the art.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for operating an image display apparatus, the method comprising:
displaying a two-dimensional (2D) content screen;
converting 2D content into three-dimensional (3D) content when a first hand gesture is input; and
displaying the converted 3D content.

2. The method according to claim 1, wherein the converting includes, when a second gesture associated with depth adjustment is input after the first hand gesture is input, setting a depth of the 3D content based on the input second gesture and converting the 2D content into the 3D content based on the set depth.

3. The method according to claim 1, further comprising sensing a position and distance of a user;
wherein the converting includes converting the 2D content into 3D content and arranging multi-view images of the converted 3D content based on at least one of the position and distance of the user, and
wherein the displaying the 3D content includes
displaying the arranged multi-view images and splitting the multi-view images.

4. The method according to claim 3, wherein the converting includes, when a second gesture associated with depth adjustment is input after the first hand gesture is input, setting a depth of the 3D content based on the input second gesture and converting the 2D content into 3D content based on the set depth.

5. The method according to claim 3, wherein the converting includes changing arrangement of the multi-view images according to change in the position of the user.

6. The method according to claim 1, wherein the first hand gesture includes a gesture of raising both hands of the user for a predetermined time.

7. The method according to claim 2, wherein the second gesture includes a gesture of moving both hands of the user toward a display or in an opposite direction of the display.

8. The method according to claim 1, further comprising:
displaying an object indicating that the displayed content is 2D content; and
displaying an object indicating the 2D content is being converted into the 3D content, during content conversion.

9. The method according to claim 1, further comprising fluctuating a portion of an edge of the 2D content during content conversion.

10. The method according to claim 1, further comprising:
displaying an object capable of changing channels or volume based on a user gesture;
sensing the user gesture; and
controlling the channel or volume based on the sensed user gesture.

11. The method according to claim 1, further comprising:
sensing a user gesture;
displaying a recent execution screen list according to the user gesture; and
when any one of the recent execution screen list is selected, displaying the selected recent execution screen.

12. A method for operating an image display apparatus, the method comprising:
displaying a two-dimensional (2D) content screen;
displaying an object indicating that the displayed content is 2D content, when a gesture of requesting conversion of 2D content into three-dimensional (3D) content is input;
converting 2D content into 3D content based on the gesture;
displaying an object indicating that the 2D content is being converted into 3D content, during content conversion; and
displaying the converted 3D content after content conversion.

13. The method according to claim 12, wherein the converting includes, when a depth adjustment gesture is input during content conversion, converting the 2D content into 3D content based on the depth adjustment gesture.

14. An image display apparatus comprising:
a camera configured to acquire a captured image;
a display configured to display a two-dimensional (2D) content screen; and
a controller configured to recognize input of a first hand gesture based on the captured image, to convert 2D content into three-dimensional (3D) content based on the input first hand gesture, and to control display of the converted 3D content.

15. The image display apparatus according to claim 14, wherein, when a second gesture associated with depth adjustment is input after the first hand gesture is input, the controller sets a depth of the 3D content based on the input second gesture and converting the 2D content into 3D content based on the set depth.

16. The image display apparatus according to claim 14, wherein the controller recognizes a position and distance of the user based on the captured image and arranges multi-view images of the converted 3D content based on the recognized position and distance of the user.

17. The image display apparatus according to claim 14, further comprising a lens unit provided on a front surface of the display for splitting multi-view images of the converted content.

18. The image display apparatus according to claim 14, wherein the controller controls display of an object indicating that the displayed content is 2D content and display of an object indicating that the 2D content is being converted into 3D content during content conversion.

19. The image display apparatus according to claim 14, wherein the first hand gesture includes a gesture of raising both hands of the user for a predetermined time.

20. The image display apparatus according to claim 15, wherein the second gesture includes a gesture of moving both hands of the user toward a display or away from the display.
